(19) United States
(12) Patent Application Publication
(10) Pub. No.: US 2003/0108751 A1
(43) Pub. Date: Jun. 12, 2003

(54) Plated articles and methods for producing the plated articles

(76) Inventors: Yukitaka Hasegawa, Nishikasugai-gun (JP); Yosuke Maruoka, Nishikasugai-gun (JP); Hiroshi Watarai, Nishikasugai-gun (JP); Yasuhiko Ogisu, Nishikasugai-gun (JP)

Correspondence Address: POSZ & BETHARDS, PLC, 11250 ROGER BACON DRIVE, SUITE 10, RESTON, VA, 20190, US

(21) Appl. No.: 10/293,295

(22) Filed: Nov. 14, 2002

(30) Foreign Application Priority Data
Nov. 16, 2001 (JP) P2001-351515
Apr. 2, 2002 (JP) P2002-100380

(51) Int. Cl. B32B 15/08; B05D 3/10; B05D 1/36

(52) U.S. Cl. 428/458; 427/304; 427/402

(57) ABSTRACT

In the silver mirror pre-treating step, a tin[II] chloride solution with tin[II] actually serving as a co-catalyst is used for supporting tin[II] on the surface of the basecoat layer in the co-catalyst-supporting step. In the next washing step, the surface of the basecoat layer is washed with water. In the still next catalyst-supporting step, a palladium chloride solution with palladium[II] actually serving as a catalyst is used for supporting palladium[II] on the surface of the basecoat layer. After that, the resulting laminate is washed in the next washing step and then plated through silver mirror reaction in the still next plate layer-forming step.

The present application is based on Japanese Patent Applications Nos. 2001-351515 and 2002-100380, the entire contents of which are incorporated herein by reference.

### BACKGROUND OF THE INVENTION

1. Field of the Invention

The present invention relates to methods for producing plated articles having a metal plate layer on the surface of a substrate layer.

2. Related Art

For plated articles of the type, heretofore known are those having a substrate layer, a basecoat layer to be a lower layer, a silverplate layer for a metal plate layer, and a topcoat layer to be a covering layer. For the basecoat layer, for example, there are used urethane coating compositions, one that comprises essential ingredients of alkyd-polyol and polyester-polyol and a curing agent of adduct-type TDI (toluene diisocyanate) as well as a coating composition that contains an alkoxytitanium ester and at least one of an epoxy group-having silane coupling agent and an epoxy resin. For the topcoat layer, for example, used is an acrylurethane coating composition that comprises an essential ingredient of acryl-polyol and a curing agent of isocyanate.

For producing such laminate articles, for example, employable is a method mentioned below. The method comprises applying the urethane coating composition to the surface of a substrate layer followed by drying it to form a basecoat layer thereon. Next, the surface of the basecoat layer is brought into contact with an aqueous solution of tin[II] chloride (SnCl₂) to thereby make the layer carries thereon tin[II] that serves as a catalyst for silver mirror reaction for silver deposition. Next, an aqueous solution that contains silver ions is applied to the surface of the basecoat layer to thereby deposit silver thereon through silver mirror reaction to form a silver plate layer on the basecoat layer. With that, this is repeatedly washed and dried, and the acrylurethane coating composition or the like is applied to the dried surface of the silver plate layer and dried to thereby form a topcoat layer on the silver plate layer.

In the conventional method of producing such silver-plated laminate articles, however, the catalyst for silver mirror reaction, Sn²⁺ is unstable and is readily oxidized into Sn⁴⁺ by the dissolved oxygen in the pre-treating chemical or by oxygen that it absorbs from air. The resulting Sn⁴⁺ could not serve as a catalyst for silver mirror reaction. Naturally, therefore, the Sn²⁺ concentration in the pre-treating chemical decreases with further oxidization of Sn²⁺ into Sn⁴⁺ therein, and, as a result, the catalyst activity of the pre-treating chemical lowers. In addition, the tin[II] having acted as the catalyst for reduction of Ag⁺ in silver mirror reaction remains as a catalyst residue between the silver plate layer and the undercoat layer. Tin[O] that results from the catalyst residue causes cell corrosion when external water penetrates into the plated articles, and it often oxidizes and ionizes silver to thereby make the ionized silver soluble in water. If so, the silver plate layer is decolored or the silver plate layer is delaminated from the undercoat layer, therefore causing one reason of deteriorating the laminate products.

On the other hand, the tin[IV] that results from the catalyst residue may exist in the laminates in the form of SnOCl₂ therein. This SnOCl₂ releases O²⁻ and Cl⁻ when it meets water having penetrated into the laminates from the outside, and will further promote the corrosion of the silver plate layer.

To solve the problems, the laminates of the conventional constitution mentioned above are repeatedly washed with water for removing the tin compounds having still remained on their surfaces after silver mirror reaction, but the washing after the reaction is limited. Therefore, there is a probability that tin compounds may exist in the laminates far beyond the estimated range thereof, and there still remains the problem of oxidation of the silver plate layer of the conventional laminates.

Moreover, the laminate articles produced according to the conventional method have a problem of poor durability in that the silver plate layer and the topcoat layer delaminate in their interface in the durability test of the laminate articles.

### SUMMARY OF THE INVENTION

The present invention has been made in consideration of the problems with the prior-art technique mentioned above. Its object is to provide plated articles that are free from the problems of discoloration and delamination to be caused by the corrosion of the metal plate layer therein, and to provide methods for producing them. Specifically, the present invention is addressed to provide plated articles and methods for producing plated articles in which adhesion strengths of the interfaces between the metal plate layer and the topcoat layer as well as between the metal plate layer and the basecoat layer are so high that the plate layer is free from the problem of delamination in the interfaces.

(1) To attain the object as above, the invention provides a plated article having at least a metal plate layer on the surface of a substrate layer, in which the metal plate layer is formed with a catalyst supported on the substrate layer or on a lower layer formed between the metal plate layer and the substrate layer and in which the difference in the standard electrode potential between the metal to form the metal plate layer and the substance to be the catalyst is smaller than 0.65 eV in terms of the absolute value.

In plated articles, if a metal to form the metal plate layer and any other ionizable substance that differs from it (principally the residue of the catalyst used in forming the metal plate layer and still remaining in the layer, and its converted derivatives) exist together, the two may undergo electron transfer therebetween whereby the metal to form the metal plate layer is often oxidized to cause cell corrosion. The corrosion is more serious when the difference in the standard electrode potential between the metal to form the metal plate layer and the ionizable substance is larger.

To solve the problem, in the invention, a substance of such that the difference in the standard electrode potential between the metal to form the metal plate layer and the substance is smaller than 0.65 eV in terms of the absolute value is used for the catalyst in forming the metal plate layer, and the metal plate layer is formed on the surface of the lower layer. Accordingly, in this, there occurs little electron transfer between the metal to form the metal plate layer and the catalyst residue, and the metal to form the metal plate layer is prevented from being corroded. As a result, the metal plate layer is free from the problems of decoloration and delamination to be caused by the corrosion of the metal to form the metal plate layer.

(2) In the invention, the metal plate layer is coated with an upper layer to protect it.

Another advantage of the invention is that water more hardly penetrates into the interface between the lower layer and the metal plate layer of the plated article. Accordingly, in this, there occurs little electron transfer between the metal to form the metal plate layer and the catalyst residue, and the metal to form the metal plate layer is prevented from being corroded. Therefore, the corrosion resistance of the metal plate layer in this is further improved.

(3) In the invention, the metal to form the metal plate layer is silver.

Another advantage of the invention is that the high brightness of the silver plate layer lasts long.

(4) In the invention provides a method for producing plated articles having at least a metal plate layer on the surface of a substrate layer, which comprises, for forming the metal plate layer, a catalyst-supporting step of making a substance to be a plating catalyst supported on the surface of a lower layer that underlies the metal plate layer on the condition that the difference in the standard electrode potential between the metal to form the metal plate layer and the substance to be the plating catalyst is smaller than 0.65 eV in terms of the absolute value, and a plating step of forming the metal plate layer on the catalyst-carrying lower layer.

The advantages of the above (4) are almost the same as those of the invention as described in (1).

(5) The invention comprises a co-catalyst-supporting step of making a co-catalyst supported on the surface of the lower layer prior to the catalyst-supporting step, in which the co-catalyst is to assist the catalyst supporting onto the surface of the lower layer.

Another advantage of the invention is that the catalyst, of which the standard electrode potential is near to that of the metal to form the metal plate layer but which is difficult to directly support on the lower layer, is readily supported on the lower layer by substituting it with the co-catalyst previously supported on the lower layer. In this, therefore, the metal plate layer is resistant to corrosion and is easy to form.

(6) In the invention, the metal to form the metal plate layer is silver.

The advantages of the invention of the above (6) are almost the same as those of the invention as described in (3).

(7) In the invention, the difference in the standard electrode potential between the catalyst and silver is at most 0.2 eV in terms of the absolute value.

Another advantage of the invention is that the difference in the standard electrode potential between silver to form the silver plate layer and the catalyst is small and therefore silver corrosion is more effectively prevented. The catalyst of which the standard electrode potential differs from that of silver to form the silver plate layer by at most 0.2 eV in terms of the absolute value includes, for example, palladium[II], iron[III], rhodium[III], tellurium[VI], iodine[O], rhenium[VI], osmium[IV], platinum[II] and mercury[II].

(8) The invention provides a method for producing plated articles having at least a metal plate layer on the surface of a substrate layer, which comprises a plating step of forming the metal plate layer and a catalyst-supporting step of making a catalyst, tin[II] supported on the surface of a lower layer that underlies the metal plate layer, and in which tin[II] for the catalyst accounts for at least 95% of all tin in the pre-treating chemical used in the catalyst-supporting step.

In the above (8), the tin[II] concentration in the pre-treating chemical is high and therefore the amount of the catalyst (tin[II]) to be supported on the surface of the lower layer increases. Accordingly, in this, metal deposition is more promoted to form the metal plate layer. In addition, the metal deposition to form the metal plate layer on the surface of the lower layer is prevented from fluctuating, and the quality of the plated articles is bettered.

Of all tin, tin[IV] is unfavorable to the pre-treating chemical for metal plating, since it has a high affinity for substances such as oxygen and chlorine that promote the corrosion of the metal of the metal plate layer and since it does not serve as the catalyst for metal plating. In the invention of the above (8), the tin[IV] content of the pre-treating chemical used is small. Therefore, in this, the amount of tin[IV] to remain in the interface between the metal plate layer and the lower layer of the plated articles is reduced, and the metal plate layer is free from the problems of decoloration and delamination.

(9) The invention provides a method for producing plated articles having at least a metal plate layer on the surface of a substrate layer, which comprises a plating step of forming the metal plate layer and a catalyst-supporting step of making a catalyst supported on the surface of a lower layer that underlies the metal plate layer, and in which the pre-treating chemical used in the catalyst-supporting step is subjected to oxidation retardation for retarding the oxidation of the active ingredient of the chemical that actually serves as the catalyst in the plating step.

In the invention of the above (9), the pre-treating chemical is subjected to oxidation retardation by which the active ingredient of the chemical is prevented from being oxidized. Accordingly, the pre-treating chemical may contain a larger amount of the active ingredient effective for forming the metal plate layer. In addition, the pre-treating chemical can be kept sable for a relatively long period of time while its active ingredient concentration is prevented from being lowered, and its maintenance is easy.

In the catalyst-supporting step, the pre-treating chemical to be used is subjected to oxidation retardation whereby a larger amount of the active ingredient can be readily supported on the surface of the lower layer. As a result, the metal plate layer can be efficiently deposited on the surface of the lower layer. In addition, the metal deposition to form the metal plate layer on the surface of the lower layer is prevented from fluctuating, and the quality of the plated articles is bettered.

Further, in the pre-treating chemical which is to assist the formation of the metal plate layer, the amount of the non-active ingredient that does not substantially serve as the catalyst is small. Therefore, the amount of the non-active ingredient to remain in the interface between the metal plate layer and the lower layer of the plated articles is reduced. In particular, in case where the non-active ingredient has a high affinity for substances such as oxygen and chlorine that promote the corrosion of the metal of the metal plate layer, this embodiment in which the non-active ingredient of the pre-treating chemical is reduced is more effective for preventing decoloration and delamination of the metal plate layer.

(10) In the invention, the treatment for oxidation retardation of the pre-treating chemical includes adding thereto an oxidation-retardant component effective for retarding the oxidation of the active ingredient of the pre-treating chemical.

Additional advantage of the invention in which an oxidation-retardant component is added to the pre-treating chemical is that the oxidation of the active ingredient of the pre-treating chemical is prevented not requiring any specific treating device and not requiring any troublesome operation. Accordingly, by this feature, the pre-treating chemical is readily stabilized.

(11) The oxidation-retardant component is a polyalcohol.

(12) An additional advantage of the invention in which a polyalcohol is used for the oxidation-retardant component is that the metal of the metal plate layer is more effectively prevented from being corroded.

In the invention, the treatment for oxidation retardation of the pre-treating chemical includes preparing the pre-treating chemical by adding a solute or a dispersoid to a medium from which the dissolved oxygen has been degassed.

(13) In the invention, the treatment for oxidation retardation of the pre-treating chemical includes degassing the dissolved oxygen from the pre-treating chemical.

(14) In the invention, the treatment for oxidation retardation of the pre-treating chemical includes keeping the pre-treating chemical under the conditions under which any oxygen transmission is blocked out between the environment where the pre-treating chemical is disposed and the external environment divided from that environment.

An additional advantage of the invention is provided in that the active ingredient of the pre-treating chemical that actually serves as the catalyst for metal plating is prevented from being oxidized by the dissolved oxygen in the chemical and by any external oxygen. Accordingly in these embodiments, the concentration of the active ingredient of the pre-treating chemical does not reduce, and the chemical well acts as the catalyst for forming the metal plate layer. In addition, in these, the amount of oxygen to be taken into the plated articles is reduced, and the metal of the metal plate layer of the products is prevented from being corroded. Further, when the pre-treating chemical is pre-degassed or is stored in a closed container, then the concentration of the active ingredient thereof is more favorably prevented from lowering and the pre-treating chemical is kept stable for a longer period of time, and, in addition, the maintenance of the chemical is easier.

(15) The invention provides a method for producing plated articles, which comprises combining the production method of any one of (4) to (7) and the production method of any one of (9) to (14) for forming the plate layer of the plated articles.

(16) The invention provides a method for producing plated articles, which comprises combining the production method of (8) and the production method of any one of (9) to (14) for forming the plate layer of the plated articles.

The invention makes it possible to more effectively prevent the metal of the metal plate layer of the plated articles from being corroded. Accordingly, the plated articles produced according to the invention of this embodiment can be used under any severe conditions.

(17) The invention provides a method for producing plated articles having a basecoat layer, a metal plate layer and a topcoat layer on the surface of a substrate, which comprises forming the basecoat layer and the metal plate layer on the surface of the substrate, then processing the surface of the metal plate layer with a reducing solution, and thereafter forming the topcoat layer on the surface of the metal plate layer.

According to this method, the adhesion strength between the metal plate layer and the topcoat layer is increased to prevent the delamination in the interface between the two layers. The reason will be because the oxide film on the metal surface is reduced to form highly reactive functional groups such as hydroxyl groups on the metal surface.

(18) In the invention, the reducing solution contains a substance that releases a sulfite ion in an aqueous solution.

By this feature, the sulfite ion has an extremely high reducing ability and therefore readily reduces the surface of the metal plate layer covered with an oxide film. Accordingly, the surface of the metal plate layer receives hydroxyl groups, which are functional groups of extremely high polarity, through the reduction of the sulfite ions thereon. As a result, the metal plate layer may increase the number of bonding points therein to the topcoat layer through intermolecular force of the two layers. Accordingly, the adhesion strength between the metal plate layer and the topcoat layer further increases to thereby more effectively prevent the delamination of the two layers at the interface therebetween.

(19) In the invention, the reducing solution is an aqueous solution of at. least one substance selected from sulfurous acid, sulfites and hydrogensulfites.

By this feature, sulfite ions are readily released in the aqueous solution to give hydroxyl groups, which are functional groups of extremely high polarity, to the surface of the metal plate layer through their reduction. Therefore, in this, the metal plate layer may increase the number of bonding points therein to the topcoat layer through intermolecular force of the two layers. Accordingly, the adhesion strength between the metal plate layer and the topcoat layer increases to thereby effectively prevent the delamination of the two layers at the interface therebetween.

(20) In the invention, the reducing solution contains a substance that releases a divalent metal ion in an aqueous solution.

By this feature, the divalent metal ion has an extremely high reducing ability and therefore readily reduces the surface of the metal plate layer covered with an oxide film. Accordingly, the surface of the metal plate layer receives hydroxyl groups, which are functional groups of extremely high polarity, through the reduction of the divalent metal ions thereon. As a result, the metal plate layer may increase the number of bonding points therein to the topcoat layer through intermolecular force of the two layers. Accordingly, the adhesion strength between the metal plate layer and the topcoat layer increases to thereby effectively prevent the delamination of the two layers at the interface therebetween.

(21) In the invention, the reducing solution is an aqueous solution of at least one substance selected from Sn(II) salts or Fe(II) salts.

This embodiment enjoys almost the same advantages as those of the invention (1) and (4).

(22) In the invention, the reducing solution is an aqueous solution of an organic acid.

By this feature, the organic acid reduces the surface of the metal plate layer covered with an oxide film. Accordingly, the surface of the metal plate layer receives hydroxyl groups, which are functional groups of extremely high polarity, through the reduction of the organic acid kept in contact with it. As a result, the metal plate layer may increase the number of bonding points therein to the topcoat layer through intermolecular force of the two layers. Accordingly, the adhesion strength between the metal plate layer and the topcoat layer increases to thereby effectively prevent the delamination of the two layers at the interface therebetween.

(23) In the invention, the organic acid is selected from oxalic acid, formic acid, malonic acid, acetic acid, succinic acid, propionic acid, glutaric acid and butyric acid.

By this feature, the organic acid has a relatively low acid strength, and it protects the surface of the metal plate layer from being too much etched. Accordingly, in this, when the concentration of the organic acid is controlled to be not higher than a predetermined level, the metal plate layer does not lose the brightness of its mirror surface and increases its adhesion strength to the topcoat layer. In addition, since the organic acid of low acid strength is used herein, it ensures working safety.

(24) The invention provides a method for producing plated articles having a basecoat layer, a metal plate layer and a topcoat layer on the surface of a substrate, which comprises forming the basecoat layer and the metal plate layer on the surface of the substrate, then processing the surface of the metal plate layer with an organic carboxylic acid solution, and thereafter forming the topcoat layer on the surface of the metal plate layer.

In this method, the surface of the metal plate layer shall receive the carboxyl group (—COOH) of the organic carboxylic acid. The carboxyl group is a functional group of extremely high polarity, and therefore increases the number of bonding points in the metal plate layer to the topcoat layer through intermolecular force of the two layers. Accordingly, the adhesion strength between the metal plate layer and the topcoat layer further increases to thereby more effectively prevent the delamination of the two layers at the interface therebetween.

(25) In the invention, the organic carboxylic acid solution is an aqueous solution of at least one substance selected from oxalic acid, formic acid, malonic acid, acetic acid, succinic acid, propionic acid, glutaric acid and butyric acid.

This embodiment enjoys almost the same advantages s those of the invention of (23).

(26) In the invention, the metal to form the metal plate layer is silver.

By this feature, the silver plate layer shall have functional groups of extremely high polarity in its surface to thereby increase its adhesion to the topcoat layer. As a result, in this, the delamination in the interface between the silver plate layer and the topcoat layer is prevented. Accordingly, the silver plate layer keeps its brightness for a long period of time and the quality of the metal-plated layer is high.

### BRIEF DESCRIPTION OF THE DRAWINGS

FIG. 1 is a cross-sectional view schematically showing a part of the plated article produced according to the embodiments of the invention;

FIG. 2 is a flowchart showing a method for producing plated articles according to the embodiments of the invention;

FIG. 3 is a flowchart showing another method for producing plated articles according to the embodiments of the invention;

FIG. 4 is a view schematically showing the bonding points between a topcoat layer and a silver plate layer processed with a reducing solution;

FIG. 5 is a flowchart showing a method for producing plated articles according to the embodiments of the invention;

FIG. 6 is a view schematically showing the bonding points between a topcoat layer and a silver plate layer processed with an organic carboxylic acid solution;

FIG. 7 shows test data of corrosion resistance of plated articles;

FIG. 8 is a graph showing the relationship between the concentration of sodium hydrogensulfite and the tensile strength of plated samples in pull-off test; and

FIG. 9 is a graph showing the relationship between the concentration of acetic acid and the tensile strength of plated samples in pull-off test.

### DETAILED DESCRIPTION OF THE PREFERRED EMBODIMENTS

First Embodiment

First Embodiment of the invention is described in detail hereinunder with reference to the drawings attached hereto.

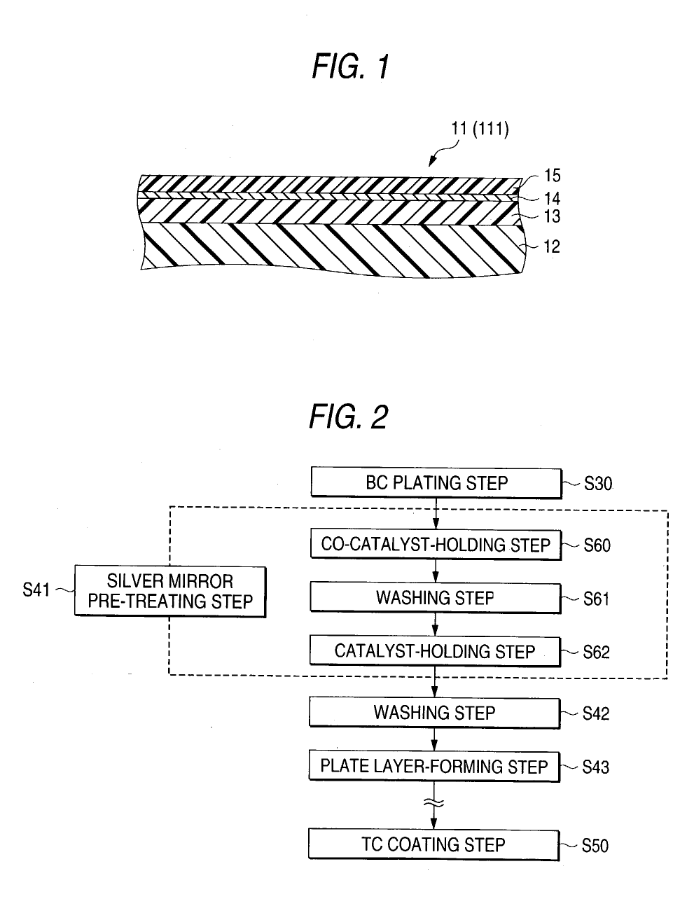

As in FIG. 1, a plated article 11 comprises a basecoat layer 13 (BC layer) of a lower layer, a silver plate layer 14 of a metal plate layer and a topcoat layer 15 (TC layer) of an upper layer formed on the surface (decorative face) of a substrate layer 12 made of synthetic resin.

The substrate layer 12 is made of, for example, a thermoplastic elastomer (TPE) such as ABS (acrylonitrile-butadiene-styrene copolymer), PC (polycarbonate)/ABS alloy, PP (polypropylene), PMMA (polymethyl methacrylate) or olefinic thermoplastic elastomer (TPO), etc., and it is formed, for example, in any known injection-molding method.

The basecoat layer 13 is formed on the surface of the substrate layer 12 by applying a basecoat agent thereto or by dipping the substrate layer 12 in the agent followed by drying the resulting laminate. The basecoat agent includes polyester resin, alkyd resin, acrylic resin, etc., for which preferred is a two-pack curable polyurethane resin as its coating is easy.

The silver plate layer 14 is formed on the surface of the basecoat layer 13 in a chemical plating method (electroless plating method) through silver mirror reaction. Precisely, an ammoniac silver nitrate ([Ag(NH₃)₂⁺OH⁻) solution (Tollens' reagent) and a reducing agent solution are applied onto the surface of the basecoat layer 13 while they are mixed thereon to induce redox reaction to thereby deposit the metal silver (Ag) to form the metal plate layer. For the reducing agent solution, preferred is an aqueous solution of an organic compound having an aldehyde group (R—CHO) such as glyoxal, or sodium sulfite or sodium thiosulfate.

The topcoat layer 15 is to protect the silver plate layer 14. This is formed on the surface of the silver plate layer 14 by applying a topcoat agent thereto or by dipping the silver-plated substrate in the agent followed by drying the resulting laminate. The topcoat agent includes polyester resin, acrylic resin, etc., for which preferred is a two-pack curable polyurethane resin or acryl-modified silicone resin as its coating is easy.

Next described is a method for producing the plated article 11.

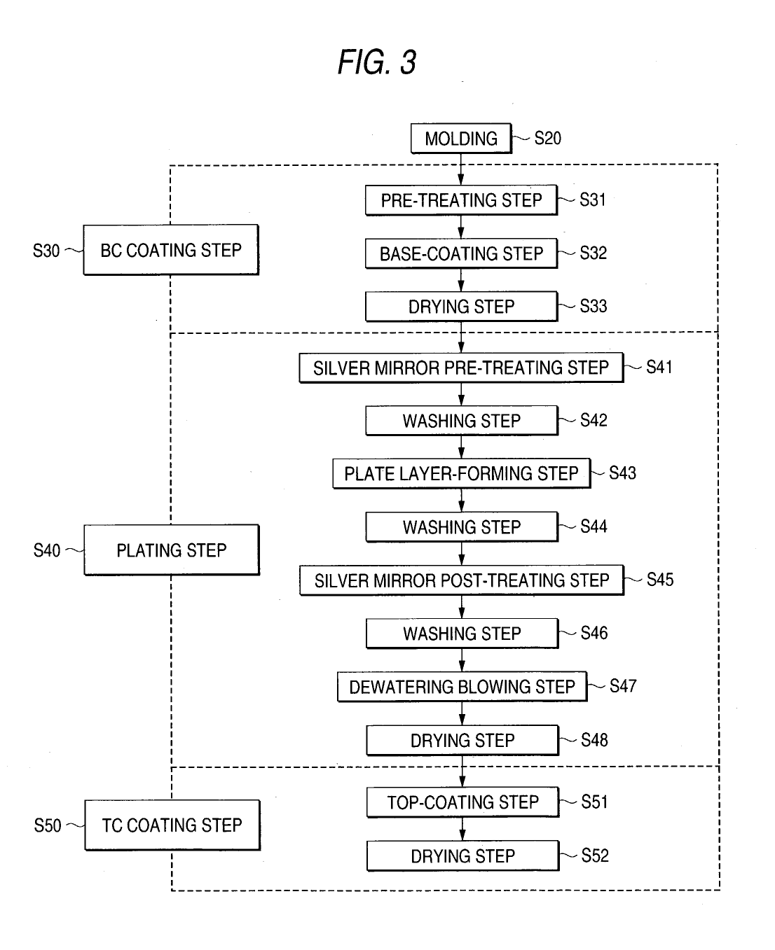

As in FIG. 3 that shows the flowchart of producing the plated article 11, the substrate layer 12 is first formed to have a predetermined shape through injection molding in the step S20, which is then followed by a base-coating step (BC coating step) of S30.

The base-coating step of S30 is to form the basecoat layer 13 of a basecoat agent on the surface of the molded substrate layer 12. In the base-coating step, the surface (decorative face) of the molded substrate layer 12 is first washed well with detergent such as isopropanol in the pre-treating step of S31. In the next base-coating step of S32, the decorative face of the washed substrate layer 12 is uniformly coated with a basecoat agent. For coating the layer 12 with the basecoat agent in the step S32, anymode of coating it therewith or dipping it in the agent may be employed. As being easy, preferred is spraying the agent on the layer 12. For the basecoat agent, for example, preferred is a) FUJIKURAKASEI CO.,LTD. “EB2854A-5” or OHASHI CHEMICAL INDUSTRIES LTD. “771”, which is a two-pack curable urethane coating composition in which the essential ingredient comprises a backbone chain of acryl-polyol (70%) and side branches of alkyd-polyol (30%) and the curing agent is a biuret-type HMDI and in which the ratio of NCO/OH is 1/1, or b) Origin ELECTRIC CO. LTD. “E-1”, which is an epoxy-based coating composition in which the essential ingredient is an epoxy resin and the curing agent is an amine compound.

In the next drying step of S33, the basecoat agent having been applied to the decorative face of the substrate layer 12 is dried. In case where “EB2854A-5” or “E-1” mentioned above is used for the basecoat agent, it is dried at a temperature of about 80° C. for about 60 minutes. On the other hand, when “771” mentioned above is used, it is dried at a temperature of about 80° C. for about 30 minutes. The drying step S33 is then followed by the next plating step of S40.

The plating step S40 is to form the silver plate layer 14 on the basecoat layer 13. In the first silver mirror pre-treating step of S41, a catalyst-containing pre-treating chemical is applied onto the dried surface of the basecoat layer 13 or the dried laminate is dipped in the chemical to thereby make the catalyst supported on the surface of the basecoat layer 13. The catalyst promotes the initial nucleation of silver to form the silver plate layer 14 on the surface of the basecoat layer 13 to thereby facilitate the silver deposition on that surface. In the next washing step of S42, the surface of the basecoat layer 13 is washed with ion-exchanged water or distilled water (preferably having a conductivity of at most 3 μS/m³) to thereby remove the excess pre-treating chemical not supported on the surface of the basecoat layer 13.

In case where the catalyst is tin (Sn) and the pre-treating chemical is a solution of tin[II] chloride (SnCl₂), tin is in the form of tin[II] in the solution and this tin[II] serves as the catalyst. However, tin[II] is unstable and is therefore readily oxidized by the dissolved oxygen in the tin[II] chloride solution or by oxygen in air into tin[IV].

As compared with tin[II], tin[IV] has a high affinity for ionizable substances, especially for oxygen and chlorine that promote the corrosion of the silver plate layer 14. Therefore, if tin[IV] co-exists, along with oxygen and chlorine, in the interface between the basecoat layer 13 and the silver plate layer 14, the co-existing elements undergo electron transfer therebetween to thereby oxidize silver of the silver plate layer 14, and, as a result, the thus-oxidized silver plate layer 14 becomes soluble in water having penetrated into the plated article from the outside. Such cell corrosion causes decoloration of the silver plate layer 14 and delamination of the silver plate layer from the basecoat layer, and this is one cause of deteriorating the plated article 11. In addition, the difference in the standard electrode potential between tin and silver to form the silver plate layer 14 is large (the difference between tin[IV] and silver is 0.65 eV in terms of the absolute value). The large difference in the standard electrode potential therebetween is one cause of promoting cell corrosion.

In addition, tin[IV] may exist to form SnOCl₂ in the interface between the basecoat layer 13 and the silver plate layer 14. The compound SnOCl₂ releases O²⁻ and Cl⁻ while the cell corrosion goes on, and these may further promote the corrosion of the silver plate layer 14.

Moreover, tin[IV] could not be the catalyst for silver mirror reaction, and when tin[II] is much oxidized in the solution of tin[II] chloride, the tin[II] concentration in the solution naturally decreases and, as a result, the catalyst activity of the solution is thereby lowered. If the solution having such a lowered tin[II] concentration is used in the silver mirror pre-treating step S41, the proportion of tin[II] supported on the surface of the basecoat layer 13 decreases while, on the other hand, the proportion of tin[IV] supported thereon shall increase. As a result, in the next plate layer-forming step S43, tin[IV] supported on the surface of the basecoat layer 13 will partly interfere with the formation of the silver plate layer 14 and the formation of the silver plate layer 14 may fluctuate.

In the washing step S42, most of tin[IV] on the surface of the basecoat layer 13 is removed. However, it is almost difficult to remove tin[IV] existing inside the plated article in the washing step, and therefore, there is a probability that tin[IV] may still remain in the interface between the basecoat layer 13 and the silver plate layer 14 beyond the estimated range thereof.

By this feature, therefore, any one of the following two methods is employed in the silver mirror pre-treating step S41 for preventing much tin[IV] from being supported on the surface of the basecoat layer 13 and for preventing it from remaining in the interface between the basecoat layer 13 and the silver plate layer 14.

The first method for the silver mirror pre-treating step S41 comprises a co-catalyst-supporting step of making a co-catalyst supported on the surface of the basecoat layer 13 prior to the subsequent catalyst-supporting step. The first method is described below.

As in FIG. 2, the silver mirror pre-treating step S41 includes a co-catalyst-supporting step of S60 of applying a first pre-treating chemical that contains a co-catalyst to the surface of the basecoat layer 13 dried in the step S30, or dipping the dried laminate in the first pre-treating chemical to thereby make the co-catalyst supported on the surface of the basecoat layer 13.

In the co-catalyst-supporting step S60, for example, a solution of tin[II] chloride is used for the first pre-treating chemical. The tin[II] chloride solution contains the solute, tin[II] chloride, and hydrochloric acid. In this, for example, the amount of hydrochloric acid falls between 1 and 2 mols relative to 1 mol of tin[ I] chloride therein. Tin[II] chloride and hydrochloric acid are mixed in a predetermined ratio in a medium of pure water to prepare the first pre-treating chemical. Preferably, the pure water to be used has a conductivity of at most 3 μS/m³, more preferably at most 0.5 μS/m³, even more preferably at most 0.05 μS/m³. Tin[II] existing in the tin[II] chloride solution is to be the active ingredient that actually serves as the co-catalyst in forming the silver plate layer 14. The first pre-treating chemical is not limited to the tin[II] chloride solution that comprises the ingredients as above, but may be, for example, Metal Processing Technology Institute's “K”.

The co-catalyst-supporting step with the first pre-treating chemical is followed by the next washing step of S61, in which the surface of the basecoat layer 13 is washed with ion-exchanged water or distilled water (preferably having a conductivity of at most 3 μS/m³) to thereby remove the excess co-catalyst remaining on that surface.

In the next catalyst-supporting step of S62, a second pre-treating chemical that contains a catalyst is applied to the surface of the basecoat layer 13 that carries the co-catalyst thereon, or the laminate is dipped in the second pre-treating chemical to thereby make the catalyst supported on the surface of the basecoat layer 13. In this step, the catalyst is substituted with the co-catalyst having been supported on the surface of the basecoat layer 13 in the previous co-catalyst-supporting step S60, and is thus supported on the surface of the basecoat layer 13. By this feature, the catalyst is so designed that the difference in the standard electrode potential between the catalyst and the silver to form the silver plate layer 14 is smaller than 0.65 eV in terms of the absolute value. The difference in the standard electrode potential between the catalyst and the silver to form the silver plate layer 14 is preferably smaller. For example, the difference is preferably at most 0.2 eV, more preferably at most 0.1 eV in terms of the absolute value.

In the catalyst-supporting step S62, for example, the second pre-treating chemical is a solution of palladium chloride. The palladium chloride solution contains the solute, palladium chloride (PdCl₂), and hydrochloric acid. In this, for example, the amount of hydrochloric acid falls between 1 and 2 mols relative to 1 mol of palladium chloride therein. Palladium chloride and hydrochloric acid are mixed in a predetermined ratio in a medium of pure water to prepare the second pre-treating chemical. Preferably, the pure water to be used has a conductivity of at most 3 μS/m³, more preferably at most 0.5 μS/m³, even more preferably at most 0.05 μS/m³. Palladium[II] existing in the palladium chloride solution is to be the active ingredient that actually serves as the catalyst in forming the silver plate layer 14. Palladium[II] has a standard electrode potential of about +0.99 eV, and the difference in the standard electrode potential between palladium[II] and silver is about 0.19 eV in terms of the absolute value.

The second pre-treating chemical is not limited to the palladium chloride solution that comprises the ingredients as above, but may be, for example, OKUNO CHEMICAL INDUSTRIES CO. LTD. “Activator”.

Next described is the second method. In this method, a solution of tin[II] chloride having almost the same composition as that of the first pre-treating chemical mentioned above is used. Briefly, the pre-treating chemical is applied to the surface of the basecoat layer 13 in a mode of coating or dipping to thereby make the catalyst, tin[II] supported on the surface of the layer 13. In this second method, the drying step S33 is directly followed by the catalyst-supporting step S62, and the co-catalyst-supporting step S60 and the washing step S61 are omitted.

In the second method, however, it is indispensable that tin[II] accounts for at least 95% of all tin in the pre-treating chemical for use in the catalyst-supporting step S62. Preferably, tin[II] accounts for at least 97%, more preferably at least 99% of all tin in the pre-treating chemical.

If tin[II] accounts for smaller than 95% of all tin in the pre-treating chemical used in the step S62 in the second method, the amount of the residue of the non-effective ingredient (tin[IV]) not actually serving as the catalyst in forming the silver plate layer 14 but remaining in the interface between the basecoat layer 13 and the silver plate layer 14 increases. If so, the silver to form the silver plate layer 14 in the plated article 11 produced in the method is readily corroded, and, as a result, the silver plate layer 14 may be decolored and delaminated. If so, in addition, tin[IV] supported on the surface of the basecoat layer 13 will partly interfere with the formation of the silver plate layer 14 and the formation of the silver plate layer 14 may fluctuate.

The pre-treating chemical is not limited to the tin[II] chloride solution that comprises the ingredients as above, but may be, for example, Metal Processing Technology Institute's “K”. However, in case where “K” is used, tin[II] must account for at least 95% of all tin therein.

The pre-treating chemical to be used in the catalyst-supporting step S62 is subjected to oxidation retardation for retarding the oxidation of tin[II] in the chemical. The oxidation retardation includes, for example, the following treatments.

One treatment for oxidation retardation of the pre-treating chemical includes adding thereto an oxidation-retardant component effective for retarding the oxidation of tin[II] in the chemical of tin[II] chloride solution. For example, a polyalcohol such as glycerin or glucose is added to the solution. Regarding its amount, the polyalcohol to be added to the solution is at least equimolar to hydrochloric acid in the solution.

Another treatment for oxidation retardation of the pre-treating chemical includes preparing the pre-treating chemical by adding tin[II] chloride, hydrochloric acid and an oxidation-retardant component to pure water from which the dissolved oxygen has been degassed. The pure water to be used in preparing the pre-treating chemical in this method is preferably so degassed that the amount of the dissolved oxygen therein is at most 1.0 mg/liter, more preferably at most 0.5 mg/liter, even more preferably at most 0.2 mg/liter.

Still another treatment for oxidation retardation of the pre-treating chemical includes degassing the dissolved oxygen from the pre-treating chemical having been prepared to have a predetermined composition. Preferably, the pre-treating chemical is so degassed that the amount of the dissolved oxygen therein is at most 1.0 mg/liter, more preferably at most 0.5 mg/liter, even more preferably at most 0.2 mg/liter.

Still another treatment for oxidation retardation of the pre-treating chemical includes keeping the pre-treating chemical under the conditions under which any oxygen transmission is blocked out between the environment where the pre-treating chemical is disposed and the external environment divided from that environment. For keeping the pre-treating chemical under the intended conditions, for example, employable is an embodiment of storing the pre-treating chemical in a closed container, or an embodiment of carrying out the catalyst-supporting step S62 in an oxygen-free atmosphere, for example, in an atmosphere purged with nitrogen.

For oxidation retardation of the pre-treating chemical, any one or more of the above-mentioned treatments may be carried out either singly or as combined. However, in case where the plated article 11 produced in the method is used under severe service conditions, for example, it is for exterior parts of automobiles, the pre-treating chemical for it is preferably subjected to some of the oxidation retardation treatments combined.

The silver mirror pre-treating step S41 carried out in the manner as above is then followed by the next washing step S42, as in FIG. 2 and FIG. 3. In the washing step S42, the surface of the basecoat layer 13 is washed with ion-exchanged water or distilled water (preferably having a conductivity of at most 3 μS/m³). In this step, the excess catalyst not supported on the surface of the basecoat layer 13 is removed. The washing step S42 is followed by the next plate layer-forming step S43 of forming the silver plate layer 14 through silver mirror reaction.

In the plate layer-forming step S43, an ammoniac silver nitrate solution and a reducing agent solution are applied at the same time to the surface of the basecoat layer 13 that carries the catalyst thereon, on which the two solutions are reacted to deposit silver on the basecoat layer 13. In this step, silver is deposited around palladium[II] or tin[II] supported on the surface of the basecoat layer 13 and forms the silver plate layer 14 on the layer 13. In the plate layer-forming step, for example, preferably used are Metal Processing Technology Institute's “LA” and “LB”. Also in the plate layer-forming step, a twin-head spray gun or a concentric spray gun is conveniently used for applying the ammoniac silver nitrate solution and the reducing agent solution to the layer 13.

Next, as in FIG. 3, the surface of the silver plate layer 14 is washed with ion-exchanged water or distilled water in the washing step S44. This is for removing the solutions for silver mirror reaction still remaining on the surface of the silver plate layer 14 after the reaction, and this is then followed by the next silver mirror post-treating step S45.

The silver mirror post-treating step S45 is for removing the impurities not having been removed from the surface of the silver plate layer 14 in the previous washing step S44. The silver mirror post-treating step includes, for example, an impurities-decomposing and removing step of decomposing and removing the above-mentioned impurities, an impurities-adsorbing and removing step of adsorbing and removing the impurities, or an anti-oxidation film-forming step of forming an anti-oxidation film on the surface of the silver plate layer 14. If desired, the impurities-decomposing and removing step may be followed by the anti-oxidation film-forming step, or the impurities-adsorbing and removing step may be followed by the anti-oxidation film-forming step.

In the impurities-decomposing and removing step, a diluted acid is applied onto the surface of the silver plate layer 14 or the plated article is dipped in a diluted acid to thereby remove the impurities from the surface of the silver plate layer 14. For the acid, employable is any of acetic acid, diluted sulfuric acid, diluted hydrochloric acid or chromic acid. Preferred is acetic acid or diluted sulfuric acid as their ability to decompose and remove the impurities is good and they have few negative influences on the mirror face of the silver plate layer 14.

In the impurities-adsorbing and decomposing step, a protein dispersion is applied onto the surface of the silver plate layer 14 or the plated article is dipped in a protein dispersion so that the impurities on the surface of the silver plate layer 14 are adsorbed by the protein and are thereby removed from that surface. For the protein dispersion, employable is milk of various mammals such as cow milk, or powdered milk thereof, but preferred is a casein dispersion in a solvent of water or an aqueous solution of low-concentration alcohol.

In the anti-oxidation film-forming step, a metal surface-treating agent is applied onto the surface of the silver plate layer 14 or the plated article is dipped in the agent to thereby form a thin anti-oxidation film on the surface of the silver plate layer 14. In this step, usable is any known metal surface-treating agent not limited to silver surface treatment but applicable to treatment of various metal surfaces and plated surfaces. The metal surface-treating agent is brought into contact with the silver plate layer 14 to thereby form thereon an oxide film of high water repellency. For the metal surface-treating agent, for example, preferred is OKUNO CHEMICAL INDUSTRIES CO. LTD. “Toprinse”. In case where “Toprinse” is used for the metal surface-treating agent herein, preferred is its aqueous solution having a concentration of from 1 to 50% by weight.

In the next washing step S46, the surface of the silver plate layer 14 is washed with ion-exchanged water or distilled water. The step S46 is then followed by the next dewatering blowing step S47 in which the water drops adhering to the surface of the silver plate layer 14 are blown off with an air blower. In the next drying step S48, the plated article is dried at a temperature of about 50° C. for about 15 minutes, and then this is top-coated in the next top-coating step (TC coating step) S50.

In the top-coating step S50, a topcoat agent is applied onto the surface of the silver plate layer 14 to thereby form a topcoat layer 15 thereon. In this step, the topcoat agent is uniformly applied onto the surface of the silver plate layer 14 in the top-coating step S51. For the topcoat agent, for example, preferred is FUJIKURAKASEI CO.,LTD. “PTC-02”, “PTC-02UH(10b)”, “PTC-05N”, or OHASHI CHEMICAL INDUSTRIES LTD. “T-7”, or Origin ELECTRIC CO. LTD. “Origituke #100”.

In the next drying step S52, the topcoat agent having been applied onto the silver plate layer 14 is dried to form the intended topcoat layer 15. In case where “PTC-02” is used for the topcoat agent, it is dried at a temperature of about 70° C. for about 70 minutes. On the other hand, when “T-7” or “Origituke #100” is used for the topcoat agent, it is dried at a temperature of about 80° C. for about 30 minutes.

The plated article 11 having the constitution mentioned above is favorable to interior parts of automobiles such as meter clusters, center clusters, registers, center consoles, emblems; and exterior parts of automobiles such as wheel caps, bumper moles, wheel garnishes, grill radiators, back panels, emblems, etc. In addition, the invention is also favorable for various plated articles that are used for others than automobile parts, for example, for those for air conditioner housings, mobile phones, notebook-size personal computers, etc.

The advantages of the first embodiment of the invention are described below.

(1) In this embodiment, palladium[II] is used for the catalyst in one method of the silver mirror pre-treating step S41, and the difference in the standard electrode potential between palladium[II] that serves as the catalyst and silver that forms the silver plate layer 14 is smaller than 0.2 eV in terms of the absolute value. Using the catalyst of the type, the silverplate layer 14 is formed on the surface of the basecoat layer 13. Accordingly, in this, there occurs little electron transfer between silver to form the silver plate layer 14 and the catalyst residue or its converted derivatives, and silver to form the silver plate layer 14 is prevented from being corroded. As a result, the silver plate layer 14 is free from the problems of decoloration and delamination to be caused by the corrosion of silver to form the silver plate layer 14.

(2) In this embodiment, the silver plate layer 14 is coated with a topcoat layer 15 to protect it. Accordingly, water hardly penetrates into the interface between the basecoat layer 13 and the silver plate layer 14 of the plated article 11. Accordingly, in this, there occurs little electron transfer between silver to form the silver plate layer 14 and the catalyst residue or the like, and silver to form the silver plate layer 14 is prevented from being corroded. The corrosion resistance of the silver plate layer 14 increases.

(3) In this embodiment, the silver plate layer 14 is formed in the plated article 11. Like in the above (1) and (2), the plated article is so designed that silver corrosion is well prevented, and the silver plate layer 14 therein is kept bright for a long period of time.

(4) In this embodiment where palladium[II] is used for the catalyst in the catalyst-supporting step S62, a co-catalyst, tin[II] is once supported on the surface of the basecoat layer 13 in the co-catalyst-supporting step and thereafter the catalyst palladium[II] is supported thereon in the next catalyst-supporting step. Palladium[II] has a standard electrode potential near to that of silver to form the silver plate layer 14, but is difficult to directly support on the basecoat layer 13. In this embodiment, however, palladium[II] is easy to support on the basecoat layer 13 by substituting tin[II] having been previously supported on the layer 13 with it. Accordingly, in this, the silver plate layer 14 of good corrosion resistance is easy to form.

(5) In this embodiment where tin[II] is used for the catalyst in the catalyst-supporting step S62, at least 95% of all tin in the pre-treating chemical for it is tin[II]. Accordingly, in this, the tin[II] concentration in the pre-treating chemical is high, the amount of the catalyst to be supported on the surface of the basecoat layer 13 therefore increases, and silver is efficiently deposited to form the silver plate layer 14. In addition, the silver deposition on the surface of the basecoat layer 13 is prevented from fluctuating, and the quality of the plated article 11 is high.

Further, in the pre-treating chemical, the amount of the non-active ingredient (tin[IV]) not actually serving as the catalyst is small. Accordingly, the amount of the non-active ingredient remaining in the interface between the basecoat layer 13 and the silver plate layer 14 in the plated article 11 reduces, and the silver plate layer 14 is free from the problems of decoloration and delamination.

(6) In this embodiment where tin[II] is used for the catalyst in the catalyst-supporting step S62, the pre-treating chemical for it is subjected to oxidation retardation. One treatment for oxidation retardation includes adding a polyalcohol to the pre-treating chemical in which the polyalcohol serves as an oxidation-retardant component for the chemical. Accordingly, in this, tin[II] in the pre-treating chemical is prevented from being oxidized, and the pre-treating chemical used in forming the silver plate layer 14 contains a larger amount of tin[Ill]. In addition, the pre-treating chemical can be kept sable for a relatively long period of time while its tin[II] concentration is prevented from being lowered, and its maintenance is easy. Moreover, in this, the oxidation-retardant component is added to the pre-treating chemical, and the oxidation of tin[II] in the pre-treating chemical is prevented not requiring any specific treating device and not requiring any troublesome operation. Accordingly, in this, the pre-treating chemical is readily stabilized.

(7) In this embodiment where tin[II] is used for the catalyst in the catalyst-supporting step S62, the pre-treating chemical for it is subjected to oxidation retardation. One treatment for oxidation retardation includes preparing the pre-treating chemical by adding tin[II] chloride, hydrochloric acid and an oxidation-retardant component to pure water from which the dissolved oxygen has been degassed. Another treatment for oxidation retardation includes degassing the dissolved oxygen from the pre-treating chemical. Still another treatment for oxidation retardation includes keeping the pre-treating chemical under the conditions under which any oxygen transmission is blocked out between the environment where the pre-treating chemical is disposed and the external environment divided from that environment. Accordingly, tin[II] in the pre-treating chemical is prevented from being oxidized by the dissolved oxygen in the chemical or by any external oxygen. As a result, the tin[II] concentration in the pre-treating chemical does not reduce, and the chemical well acts as the catalyst for forming the metal plate layer 14. In addition, the amount of oxygen to be taken into the plated article 11 is reduced, and the silver of the silver plate layer is prevented from being corroded. Further, the tin[II] concentration in the pre-treating chemical is prevented from lowering, the pre-treating chemical is kept stable for a longer period of time, and the maintenance of the chemical is easier.

(8) In this embodiment where tin[II] is used for the catalyst in the catalyst-supporting step S62, tin[II] accounts for at least 95% of all tin in the pre-treating chemical for it and the pre-treating chemical is subjected to oxidation retardation. Accordingly, in this, the silver of the silver plate layer 14 is more effectively prevented from being corroded, and the production method of this embodiment is suitable to production of plated articles that may be used under severe service conditions.

(9) In this embodiment, the silver plate layer 14 is formed in a chemical plating method through silver mirror reaction. The method to form the silver plate layer 14 through silver deposition is very simple. In addition, the working operation for forming the silver plate layer 14 through silver deposition may be done extremely rapidly and easily, and this embodiment is effective for reducing the production costs.

(10) In this embodiment, the substrate layer 12 is formed of synthetic resin. Accordingly, the weight of the plated article 11 produced in this is reduced, and the embodiment allows a lot of latitude in designing the products.

(Modifications)

The embodiments of the invention may be modified, for example, as follows:

In the above-mentioned embodiments, the substrate layer 12 maybe formed of any and every material capable of being directly or indirectly coated with the basecoat layer 13. The material includes, for example, rubber, glass, porcelain and other various ceramics, and also wood and paper. Using it, various plated articles of different shapes may be fabricated. Naturally, any other thermoplastic resin or thermosetting resin than those used in the embodiments may be used to form the substrate layer 12.

In the embodiments, the topcoat layer 15 maybe replaced with any others. For example, a film may be attached, adhered or stuck to the silver plate layer 14 under pressure or an adhesive put therebetween. The modification comprises a step of providing the film on the silver plate layer 14 in place of the top-coating step S50.

The embodiments are not limited to the process in which the plating step 40 is directly followed by the top-coating step S50. For example, after the plating step 40, a detachable temporary protective layer may be provided on the silver plate layer 14. The temporary protective layer is optionally peeled off, and the silver plate layer 14 may be processed in the top-coating step S50.

In the embodiments, at least one of the basecoat layer 13 and the topcoat layer 15 may be omitted from the plated article 11. In case where the basecoat layer 13 is omitted, the base-coating step 530 shall be omitted, and the silver plate layer 14 is directly formed on the substrate layer 12 in the plating step S40.

In the embodiments, the metal plate layer of the plated article 11 may be formed of any other metal than silver. With no limitation, the invention shall apply to any and every case in which a catalyst is used in forming a metal plate layer on the surface of a substrate layer.

In the embodiments, the formation of the silver plate layer 14 is not limited to the method of using a spray gun. The layer may be formed in any other method, for example, in an electroplating method or a dipping method. With no limitation, the invention shall apply to any and every case in which a catalyst is used in forming a metal plate layer on the surface of a substrate layer.

In the embodiments, the co-catalyst to be supported on the surface of the lower layer (the base coat layer 13 or the substrate layer 12) in the co-catalyst-supporting step S60 is not limited to tin[II]. The co-catalyst maybe any and every one capable of being supported on the surface of the lower layer in the co-catalyst-supporting step S60 and capable of being substituted with the catalyst component in the catalyst-supporting step S62.

In the embodiments where the catalyst component actually effective in the plate layer-forming step S43 is directly supported on the lower layer (the basecoat layer 13 or the substrate layer 12), the co-catalyst-supporting step S60 and the washing step S61 may be omitted.

In the embodiments, the catalyst to be used in forming the silver plate layer 14 is not limited to those containing tin[II] or palladium[II]. Except tin[II] or palladium[II], the catalyst may be any others containing, for example, any of vanadium[IV], chromium[VI], iron[III], copper[II], arsenic[III], molybdenum[VII], ruthenium[II], ruthenium[III], rhodium[III], antimony[III], tellurium[IV], tellurium[VI], iodine[O], rhenium[III], rhenium[IV], rhenium[VI], rhenium[VII], osmium[IV], iridium[III], platinum[II], mercury[II], thallium[III] or bismuth[III]. These active ingredients all satisfy the requirement that their standard electrode potential difference from silver of the silver plate layer 14 is smaller than 0.65 eV in terms of the absolute value, and are therefore favorable for solving the problems of decoloration and delamination of the silver plate layer 14 to be caused by the silver corrosion of the layer 14.

Of the catalyst ingredients mentioned above, especially preferred are iron[III], rhodium[III], tellurium[VI], iodine[O], rhenium[VI], osmium[IV], platinum[II] and mercury[II] as their standard electrode potential difference from silver of the silver plate layer 14 is at most 0.2 eV in terms of the absolute value. Accordingly, the catalysts that contain any of these are more favorable for preventing silver corrosion.

In the embodiments where a catalyst solution not containing palladium[II] is used for the second pre-treating chemical, the second pre-treating chemical may be subjected to oxidation retardation for retarding the oxidation of the active ingredient of the chemical that actually serves as the catalyst in forming the silver plate layer 14. The treatment for oxidation retardation includes, for example, adding an oxidation-retardant component to the second pre-treating chemical or degassing the second pre-treating chemical.

For oxidation retardation of the pre-treating chemical, any one or more of the above-mentioned treatments may be carried out either singly or as combined. The pre-treating chemical having been subjected to such oxidation retardation is more favorable for solving the problem of silver corrosion in the silver plate layer 14, and is therefore more favorable for producing plated articles that are for use under severe service conditions.

In the embodiments where tin[II] is used for the co-catalyst in the co-catalyst-supporting step S60, the first pre-treating chemical to be used in the co-catalyst-supporting step does not always require the treatment for oxidation retardation. In these, however, it is desirable that the first pre-treating chemical is as fresh as possible not being aged too long after its preparation. Preferably, tin[II] accounts for at least 95% of all tin in the first pre-treating chemical for use in the embodiments.

0In the embodiments, the polyalcohol that serves as the oxidation-retardant component in the pre-treating chemical is not limited to glucose and glycerin. Except glucose and glycerin, the polyalcohol includes, for example, 1,3-propanediol, 1,2-propanediol, ethylene glycol, erythritol, D-erythrulose, D-erythrose, D-threose, D-arabinose, β-D-arabinose, β-L-arabinose, D-xylulose, L-xylulose, D-xylose, α-D-xylose, 2-deoxy-D-ribose, 2-deoxy-β-D-ribose, D-lyxose, α-D-lyxose, α-D-lyxose, D-ribulose, D-ribose, D-arabitol, ribitol, D-altrose, β-D-altrose, D-allose, β-D-allose, D-idose, D-galactose, α-D-galactose, β-D-galactose, α-L-galactose, D-quinovose, α-D-quinovose, D-glucose, α-D-glucose, β-D-glucose, α-cyclodextrin, β-cyclodextrin.

Second Embodiment

Second embodiment of the invention are described in detail hereinunder with reference to the drawings attached hereto.

Similar to the first embodiment, a plated article 111 of the second embodiment comprises a basecoat layer 13 of a lower layer, a silver plate layer 14 of a metal plate layer and a topcoat layer 15 of a covering layer formed on the surface (decorative face) of a substrate layer 12 made of synthetic resin as shown in FIG. 1.

For the basecoat agent of the second embodiment, for example, preferred is a two-pack curable polyurethane resin that comprises an essential ingredient of alkyd-modified acrylic polyol and a curing agent of biuret-type HMDI (hexamethylene diisocyanate), or an epoxy resin.

In the second embodiment, prior to forming the silver plate layer 14 thereon, a first pre-treating chemical that contains tin[II] chloride and hydrochloric acid is applied to the basecoat layer 13 for making tin[II] that serves as a co-catalyst supported on the layer 13. Thus processed, the basecoat layer 13 is then washed with water, and a solution of palladium[II] chloride is applied to it to thereby make palladium[II] supported on its surface. Thus supported thereon, palladium[II] serves as a catalyst for promoting initial nucleation of silver to form the silver plate layer 14.

The topcoat layer 15 of the second embodiment is to protect the silver plate layer 14. This is formed on the surface of the silver plate layer 14 by applying a topcoat agent thereto or by dipping the silver-plated substrate in the agent followed by drying the resulting laminate. For the topcoat agent, preferred is a silicone-acryl resin of high water repellency. After such a silicone-acryl resin has been applied to the layer 14 and dried thereon to form the topcoat layer 15, the layer 15 is further processed to promote crosslinking therein so that it may have a glass transition temperature (Tg) of not lower than 60° C.

Next described is a method for producing the plated article 111 of the second embodiment.

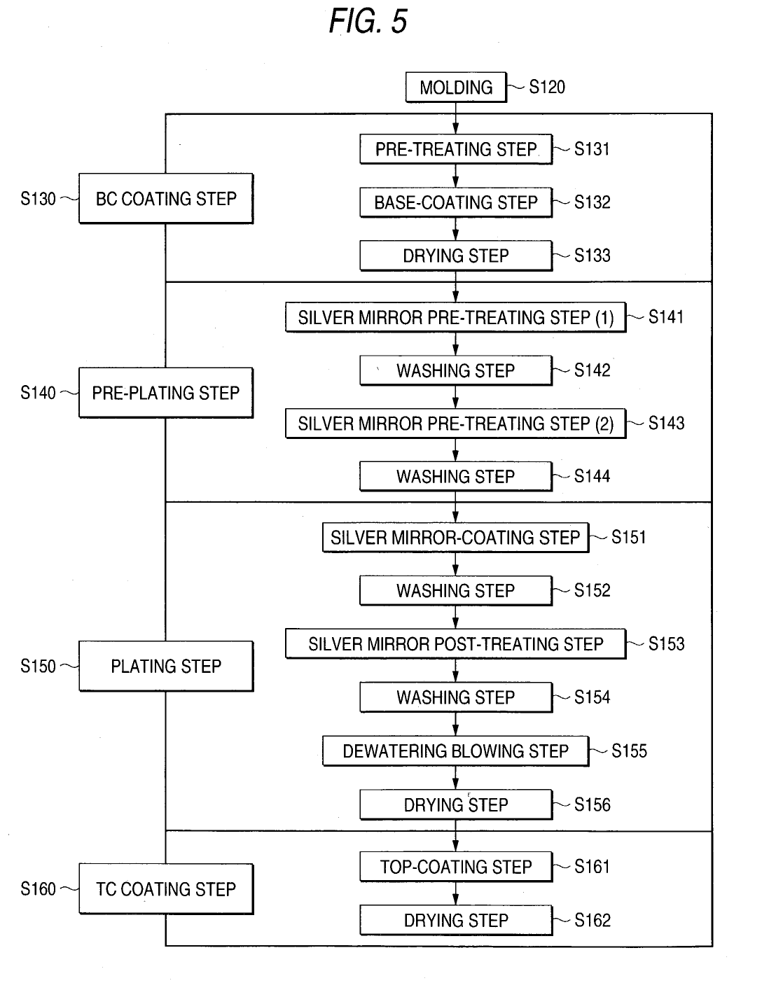

As in FIG. 5 that shows the flowchart of producing the plated article 111, the substrate layer 12 is first formed to have a predetermined shape through injection molding in the step S120, which is then followed by a base-coating step (BC coating step) of S130.

The base-coating step of S130 is to form the basecoat layer 13 of a basecoat agent on the surface of the molded substrate layer 12. In the base-coating step, the surface (decorative face) of the molded substrate layer 12 is first washed well with detergent such as isopropanol in the pre-treating step of S131. In the next base-coating step of S132, the decorative face of the washed substrate layer 12 is uniformly coated with a basecoat agent. For coating the layer 12 with the basecoat agent in the step S132, any mode of coating it therewith or dipping it in the agent may be employed. As being easy, preferred is spraying the agent on the layer 12. For the basecoat agent, for example, preferred is OHASHI CHEMICAL INDUSTRIES LTD. “771” (this is a two-pack curable urethane coating composition in which the essential ingredient comprises a backbone chain of acryl-polyol (70%) and side branches of alkyd-polyol (30%) and the curing agent is a biuret-type HMDI and in which the ratio of NCO/OH is 1/1) or Origin ELECTRIC CO. LTD. “E-1” (this is an epoxy-based coating composition in which the essential ingredient is an epoxy resin and the curing agent is an amine compound).

In the next drying step of S133, the basecoat agent having been applied to the decorative face of the substrate layer 12 is dried. In case where “E-1” mentioned above is used for the basecoat agent, it is dried at a temperature of 80° C. for 60 minutes. On the other hand, when “771” mentioned above is used, it is dried at a temperature of 80° C. for 30 minutes. The drying step S133 is then followed by the next pre-plating step of S140.

In the pre-plating step S140, the surface of the basecoat layer 13 is pre-treated for facilitating silver deposition in the subsequent plating step S150. In the first silver mirror pre-treating step (1) of S141, a co-catalyst-containing first pre-treating chemical is applied onto the dried surface of the basecoat layer 13 or the dried laminate is dipped in the chemical to thereby make the co-catalyst supported on the surface of the basecoat layer 13. For the co-catalyst, for example, preferred is tin[II]. For the first pre-treating chemical, for example, preferred is a solution of tin[II] chloride (SnCl₂) that contains hydrochloric acid.

In the next washing step of S142, the surface of the basecoat layer 13 is washed with ion-exchanged water or distilled water (preferably having a conductivity of at most 3 μS/m³) to thereby remove the excess tin[II] chloride not supported on the surface of the basecoat layer 13.

In the next silver mirror pre-treating step (2) of S143, a second pre-treating chemical that contains a catalyst is applied to the dried surface of the basecoat layer 13 or the laminate is dipped in the second pre-treating chemical to thereby make the catalyst supported on the surface of the basecoat layer 13 by substituting it with the co-catalyst on that surface. For the catalyst to be supported on the surface of the basecoat layer 13, for example, preferred is palladium[II]. For the second pre-treating chemical, for example, preferred is a solution of palladium[II] chloride (PdCl₂) or Okuno Pharmaceutical's “Activator”. In that manner, the catalyst that promotes initial nucleation of silver for the silver plate layer 14 is supported on the surface of the basecoat layer 13. In the pre-plating step, the same technique as that for nickel plating shall apply to the step of making the catalyst, palladium[II] supported on the substrate to be plated.

In the next washing step S144, the surface of the basecoat layer 13 is washed with ion-exchanged water or distilled water (preferably having a conductivity of at most 3 μS/m³). This is for removing the excess palladium[II] chloride not supported on the surface of the basecoat layer 13.

The pre-plating step S140 effected according to the method as above is followed by the next plating step S150. In the plating step, the intended silver plate layer 14 is formed through silver mirror reaction and then it is post-treated.

In the silver mirror-coating step S151, an ammoniac silver nitrate solution and a reducing agent solution are applied at the same time to the surface of the basecoat layer 13 that carries the catalyst thereon, on which the two solutions are reacted to deposit silver on the basecoat layer 13. In this step, silver is deposited around palladium[II] supported on the surface of the basecoat layer 13 and forms the intended silver plate layer 14 on the layer 13. In the silver mirror-coating step, for example, preferably used are Daitec's “LA” and “LB”. In the silver mirror-coating step, a twin-head spray gun or a concentric spray gun is conveniently used for applying the ammoniac silver nitrate solution and the reducing agent solution to the layer 13.

In the next washing step S152, the surface of the silver plate layer 14 is washed with ion-exchanged water or distilled water. This is for removing the solutions for silver mirror reaction still remaining on the surface of the silver plate layer 14 after the reaction, and this is then followed by the next silver mirror post-treating step S153.

The silver mirror post-treating step S153 is for applying a post-treating solution to the surface of the silver plate layer 14. This is for increasing the adhesion strength of the layer 14 to the topcoat layer 15 to be formed in the subsequent top-coating step S161. Specifically, in this step, a post-treating solution is applied to the silver plate layer 14 so as to increase the number of bonding points in the layer 14 to the topcoat layer 15 to be formed in S161. Through this step, the surface of the silver plate layer 14 receives functional groups of high polarity. As a result, the intermolecular force based on the polar group interaction increases in the interface between the silver plate layer 14 and the topcoat layer 15, and the adhesion strength between the silver plate layer 14 and the topcoat layer 15 is thereby increased. In this embodiment, a reducing solution or an organic carboxylic acid solution is used for the post-treating solution.

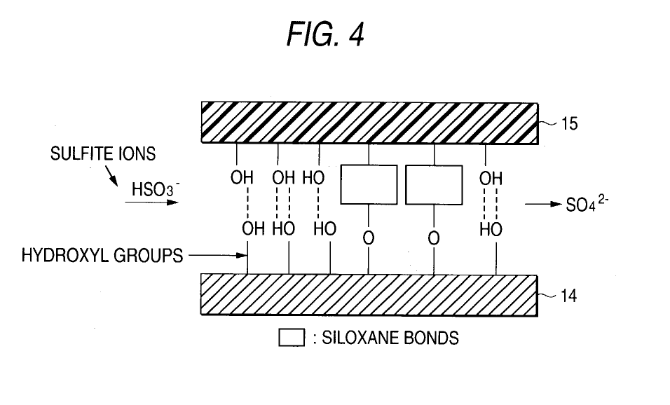

For the reducing solution, preferred is a solution that contains a substance of, for example, sulfurous acid, sulfites or hydrogensulfites. These substances rapidly release sulfite ions in their solutions. It is well known that the reducing activity of sulfite ions (HSO₃⁻) is high. As in FIG. 4, when a reducing solution that contains such sulfite ions is applied to the silver plate layer 14, it rapidly reduces the oxide film that covers the surface of the layer 14, and at the same time, it releases sulfate ions (SO₄²⁻). As a result, the surface of the silver plate layer 14 receives hydroxyl groups that are functional group of extremely high polarity.

The topcoat layer 15 is formed on the silver plate layer 14 by applying a topcoat agent of a silicone-acryl coating composition to the layer 14 in the subsequent top-coating step (TC coating step) of S160 that will be described hereinunder. The topcoat layer 15 thus formed has many hydroxyl groups, and the surface of the silver plate layer 14 therefore receives additional hydroxyl groups from the topcoat layer 15 to thereby have an increased number of intermolecular force-based bonding points to the topcoat layer 15. As a result, the adhesion strength of the silver plate layer 14 to the topcoat layer 15 is increased through the silver mirror post-treating step S153.

The reducing solution is not limited to such sulfite ion-containing solutions. For example, the reducing solution may also be a solution that contains divalent metal ions. Like sulfite ions, it is known that the reducing activity of divalent metal ions is high. Accordingly, when a reducing solution that contains such divalent metal ions is applied to the silver plate layer 14, then the oxide film to cover the silver plate layer 14 is rapidly reduced. As a result, the surface of the silver plate layer 14 shall have hydroxyl groups that are functional groups of extremely high polarity. Concretely, the divalent metal salts of high reductivity include Sn(II) salts or Fe(II) salts. In addition, the reducing solution may contain an organic acid. Processing the oxide film-covered surface of the silver plate layer 14 with an organic acid produces the same results as in the above. Apart from these, the reducing solution may contain any of hydrazine, sodium borohydride, dimethylaminoborane, sodium phosphinate, thiourea dioxide, hydrazinium chloride, L(+)−ascorbic acid, sodium thiosul fate, aqueous hydrogen peroxide.

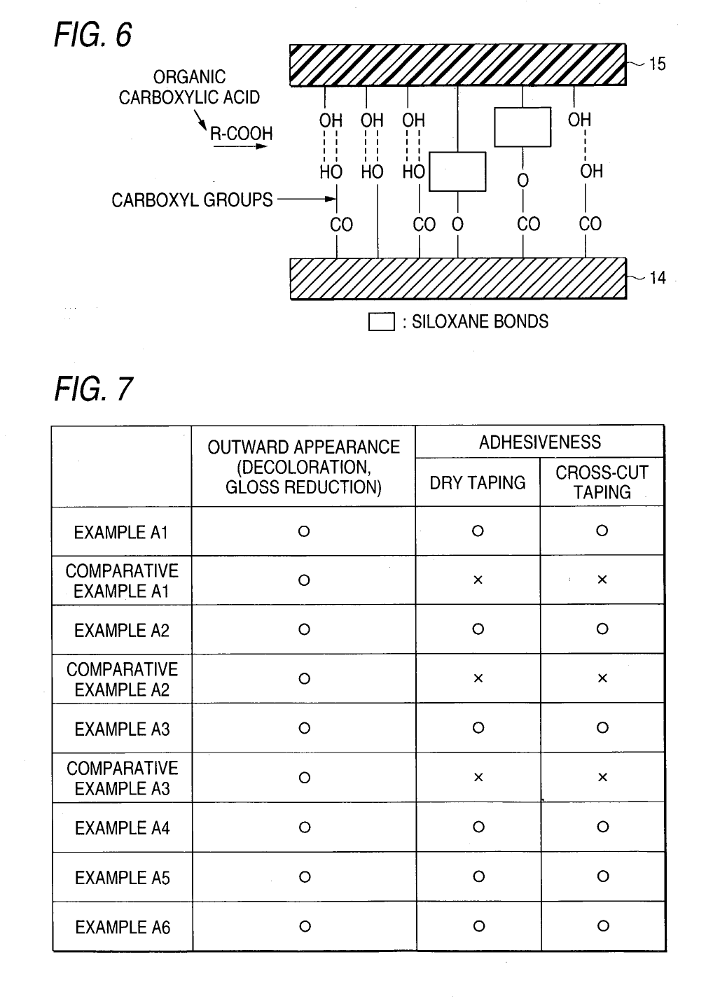

In the silver mirror post-treating step S153, an organic carboxylic acid may be used not for the reducing solution but for giving carboxyl groups to the surface of the silver plate layer 14. When an organic carboxylic acid solution is applied to the silver plate layer 14, it gives its carboxyl group to the surface of the layer 14, as in FIG. 6. Like hydroxyl group, the carboxyl group is a functional group of extremely high polarity. Accordingly, the silver plate layer 14 receives a large number of carboxyl groups in the silver mirror post-treating step S153 and therefore increases the number of bonding points therein to the topcoat layer 15. Thus increasing the number of intermolecular force-based bonding points therein, the silver plate layer 14 increases its adhesion strength to the topcoat layer 15 that is formed S161. For the organic carboxylic acid for use in this embodiment, preferred are oxalic acid, formic acid, malonic acid, acetic acid, succinic acid, propionic acid, glutaric acid and butyric acid. Using such an acid of relatively low acid strength protects the surface of the silver plate layer 14 from being too much etched.

In the next washing step S154, the surface of the silver plate layer 14 is washed with ion-exchanged water or distilled water. The step S154 is then followed by the next dewatering blowing step S155 in which the water drops adhering to the surface of the silver plate layer 14 are blown off with an air blower. In the next drying step S156, the plated article is dried at a temperature of 70° C. for 30 minutes, and then this is top-coated in the next top-coating step (TC coating step) S160.

In the top-coating step S160, a topcoat agent is applied onto the surface of the silver plate layer 14 to thereby form a topcoat layer 15 thereon. In this step, the topcoat agent is uniformly applied onto the surface of the silver plate layer 14 in the top-coating step S161. For the topcoat agent, for example, preferred is FUJIKURAKASEI CO.,LTD. “PTC-02UH(10B)” (silicone-acryl coating composition) or Origin ELECTRIC CO. LTD. “Origituke #100” (acryl-silicone coating composition). The step produces siloxane bonds of silicon and oxygen alternately bonding to each other in the interface between the silver plate layer 14 and the topcoat layer 15, as in FIG. 5 and FIG. 6. The siloxane bonds are inorganic bonds that are stable both thermally and chemically, and they essentially form the basic backbone of glass.

In the next drying step S162, the topcoat agent having been applied onto the silver plate layer 14 is dried to form the intended topcoat layer 15. In case where “PTC-02UH(10B)” is used for the topcoat agent, it is dried at a temperature of 80° C. for 60 minutes. On the other hand, when “Origituke #100” is used for the topcoat agent, it is dried at a temperature of 80° C. for 45 minutes.

The plated article III having the constitution mentioned above is favorable to interior parts of automobiles such as meter clusters, center clusters, registers, center consoles, emblems; and exterior parts of automobiles such as wheel caps, bumper moles, wheel garnishes, grill radiators, back panels, emblems, etc. In addition, the invention is also favorable for various plated articles that are used for others than automobile parts, for example, for those for air conditioner housings, mobile phones, notebook-size personal computers, etc.

The advantages of the above-mentioned embodiments of the invention are described below.

(1) The surface of the silver plate layer 14 is processed with a reducing solution, whereby the surface thereof covered with an oxide film is readily reduced. In this embodiment, the surface of the silver plate layer 14 receives functional groups of high polarity through its reduction and therefore increases the number of intermolecular force-based bonding points therein to the topcoat layer 15. Accordingly, the adhesion strength between the silver plate layer 14 and the topcoat layer 15 increases to prevent the delamination of the. two layers at their interface.

(2) The reducing solution may contain a substance that releases a sulfite ion in an aqueous solution. In this embodiment, the sulfite ion has an extremely high reducing ability and therefore readily reduces the surface of the silver plate layer 14 covered with an oxide film. Accordingly, the surface of the silver plate layer 14 receives hydroxyl groups, which are functional groups of extremely high polarity, through the reduction of the sulfite ions thereon. Therefore, the adhesion strength between the silver plate layer 14 and the topcoat layer 15 further increases to thereby more effectively prevent the delamination of the two layers at the interface therebetween.

(3) The reducing solution may contain a substance that releases a divalent metal ion in an aqueous solution. In this embodiment, the divalent metal ion has an extremely high reducing ability and therefore readily reduces the surface of the silver plate layer 14 covered with an oxide film. Accordingly, the surface of the silver plate layer 14 receives hydroxyl groups, which are functional groups of extremely high polarity, through the reduction of the divalent metal ions thereon. Therefore, the adhesion strength between the silver plate layer 14 and the topcoat layer 15 further increases to thereby more effectively prevent the delamination of the two layers at the interface therebetween. In addition, in case where the reducing solution is an aqueous solution of an organic acid, the organic acid therein also reduces the surface of the oxide film-covered silver plate layer 14 owing to its reducing activity. Therefore, in this embodiment, the surface of the silver plate layer 14 receives hydroxyl groups through the reduction of the organic acid thereon, and the adhesion strength between the silver plate layer 14 and the topcoat layer 15 further increases.

(4) Processed with an organic carboxylic acid, the surface of the silver plate layer 14 receives carboxyl groups. Like hydroxyl groups, the carboxyl groups in this embodiment are also functional groups of extremely high polarity, and the silver plate layer 14 therefore increases the number of bonding points therein to the topcoat layer 15 through intermolecular force of the two layers. Accordingly, the adhesion strength between the silver plate layer 14 and the topcoat layer 15 increases to thereby prevent the delamination of the two layers at the interface therebetween.

(5) Since the organic acid has a relatively low acid strength, and it protects the surface of the silver plate layer 14 from being too much etched. Accordingly, in this embodiment, when the concentration of the organic acid is controlled to be not higher than a predetermined level, the silver plate layer 14 does not lose the brightness of its mirror surface and increases its adhesion strength to the topcoat layer 15. In addition, since the organic carboxylic acid has a low acid strength is used herein, its solution is easy to handle and ensures working safety.

(6) The method for producing the plated article 111 of this embodiment has the advantages of above (1) to (5). Accordingly, the silver plate layer 14 does not lose its brightness and has an increased adhesion strength to the topcoat layer 15. As a result, the silver pale layer 14 keeps its brightness for a long period of time. Accordingly, the plated article 111 is suitable to members to be used under severe service conditions, for example, to exterior parts of automobiles, etc.

(Modifications)

The second embodiment of the invention may be modified, for example, as follows:

The second embodiment of the invention may be so modified that any other metal plate layer than silver and the topcoat layer 15 may be formed, either directly or via the basecoat layer 13, on the surface of the substrate layer 12 of any material of any shape. For example, the material for the substrate includes rubber, glass, porcelain and other various ceramics, and also wood and paper. In place of thermoplastic resin, the substrate layer 12 may be formed of any other thermosetting resin. In addition, the substrate layer 12 may also be formed of any other thermoplastic resin than those referred to hereinabove for the second embodiment.

In the second embodiment, the basecoat layer 13 may be omitted from the plated article 111. In case where the basecoat layer 13 is omitted, the base-coating step S130 shall be omitted, and the silver plate layer 14 is directly formed on the substrate layer 12 in the plating step S140.

In the second embodiment, the metal plate layer of the plated article 111 may be formed of any other metal than silver. For example, the metal includes nickel, gold, zinc, chromium, copper, etc.

In the second embodiment, the formation of the silver plate layer 14 is not limited to the method of using a spray gun. The layer may be formed in any other method, for example, in an electroplating method or a dipping method.

In the second embodiment, the catalyst palladium[II] to be used in forming the silver plate layer 14 is supported on the surface of the substrate layer 12 or the basecoat layer 13 in such a manner that a co-catalyst such as tin[II] is first supported on that surface prior to supporting the catalyst thereon, and thereafter the co-catalyst is substituted with the catalyst palladium[II] on that surface. However, the catalyst for use in the invention is not limited to palladium[II] alone. The catalyst may be any others containing, for example, any of vanadium[IV], chromium[VI], iron[III], copper[II], arsenic[III], molybdenum[VII], ruthenium[II], ruthenium[III], rhodium[III], antimony[III], tellurium[IV], tellurium[VI], iodine[O], rhenium[III], rhenium[IV], rhenium[VI], rhenium[VII], osmium[IV], iridium[III], platinum[II], mercury[II], thallium[III] or bismuth[III].

### EXAMPLES

The invention is described in detail hereinunder with reference to Examples of concretely demonstrating the embodiments thereof and to Comparative Examples.

### Example A1

A quadrilateral plate substrate layer 12 was formed through injection molding of ABS (S20), and its surface (decorative face) was pre-treated by spraying isopropanol thereon (pre-treating step S31). Next, a basecoat agent (OHASHI CHEMICAL INDUSTRIES LTD. “771”) was sprayed on the surface of the substrate layer 12 (base-coating step S32). This was dried in a drying kiln at 80° C. for 30 minutes (drying step S33) to thereby form a basecoat layer 13 having a uniform thickness of about 20 μm on the surface of the substrate layer 12.

Next, a first pre-treating chemical (tin[II] chloride solution) was sprayed on the surface of the basecoat layer 13 (co-catalyst-supporting step S60), and then the surface of the basecoat layer 13 was washed by spraying ion-exchanged water having a conductivity of at most 3 μS/m³ thereon (washing step S61). The tin[II] chloride solution used in the co-catalyst-supporting step S60 contains 0.092 mol/liter of tin[II] chloride and 0.110 mol/liter of hydrochloric acid in pure water having a conductivity of 0.05 μS/m³. After its preparation, the solution was kept as such for 72 hours and used in the step.

Next, a second pre-treating chemical (palladium chloride solution) was sprayed on the tin[II]-carrying surface of the basecoat layer 13 (catalyst-supporting step S62), and then the surface of the basecoat layer 13 was washed by spraying it with ion-exchanged water having a conductivity of at most 3 μS/m³ (washing step S42). The palladium chloride solution used in the catalyst-supporting step S62 contains 0.092 mol/liter of palladium chloride and 0.110 mol/liter of hydrochloric acid in pure water having a conductivity of 0.05 μS/m³.

Next, Tollens' reagent and glyoxal were simultaneously sprayed on the surface of the basecoat layer 13 through a twin-head spray gun (plate layer-forming step S43) to thereby form a silver plate layer 14 having a uniform thickness of about 0.1 μm on the surface of the basecoat layer 13. Next, the surface of the silver plate layer 14 was washed by spraying it with ion-exchanged water (washing step S44).

Next, a metal surface-treating agent (aqueous 10 wt. % solution of OKUNO CHEMICAL INDUSTRIES CO. LTD. “Toprinse”) was sprayed on the surface of the silver plate layer 14 (silver mirror post-treating step S45), and then the surface of the silver plate layer 14 was washed by spraying it with ion-exchanged water (washing step S46). Subsequently, the surface of the silver plate layer 14 was blown with compressed air (dewatering blowing step S47), and then this was dried in a drying kiln at 50° C. for 15 minutes (drying step S48).

Finally, a topcoat agent (FUJIKURAKASEI CO.,LTD. “PTC-02”) was sprayed on the surface of the silver plate layer 14 (top-coating step S51), and then dried in a drying kiln at 70° C. for 70 minutes (drying step S52) to thereby form a topcoat layer 15 having a uniform thickness of about 20 μm on the surface of the silver plate layer 14. Thus fabricated, the plated article 11 has the basecoat layer 13, the silver plate layer 14 and the topcoat layer 15 formed on the surface of the substrate layer 12.

### Comparative Example A1

The same process as in Example A1 was carried out, except that the co-catalyst-supporting step S60 and the washing step S61 were omitted and the tin[II] chloride solution having the same composition as that of the first pre-treating chemical was sprayed on the surface of the basecoat layer 13 in the catalyst-supporting step S62. Accordingly, in this, tin[II] of the tin[II] chloride solution, which is the active ingredient to actually serve as the catalyst in forming the silver plate layer 14, was directly supported on the surface of the basecoat layer 13, and the plate layer-forming step S43 was carried out in that condition. Thus fabricated, the plated article has the basecoat layer 13, the silver plate layer 14 and the topcoat layer 15 formed on the surface of the substrate layer 12. Two and the same plated articles of Comparative Example A1 were prepared, and one of them is the plated article of Comparative Example A3.

### Example A2

In this, the co-catalyst-supporting step S60 and the washing step S61 were omitted, and a pre-treating chemical, tin[II] chloride solution was sprayed on the surface of the basecoat layer 13 in the catalyst-supporting step S62. In the tin[II] chloride solution used in the catalyst-supporting step S62, the active ingredient (tin[II]) that actually serves as the catalyst in the plate layer-forming step accounts for 99% of all the catalyst component (tin). In this Example A2, the others than the above are the same as in Example A1. Thus fabricated, the plated article has the basecoat layer 13, the silver plate layer 14 and the topcoat layer 15 formed on the surface of the substrate layer 12.

### Comparative Example A2

In this, a pre-treating chemical, tin[II] chloride solution was sprayed on the surface of the basecoat layer 13 in the catalyst-supporting step S62. In the tin[II] chloride solution used in the catalyst-supporting step S62, the active ingredient (tin[II]) that actually serves as the catalyst in the plate layer-forming step accounts for 88% of all the catalyst component (tin). In this Comparative Example A2, the others than the above are the same as in Example A2. Thus fabricated, the plated article has the basecoat layer 13, the silver plate layer 14 and the topcoat layer 15 formed on the surface of the substrate layer 12.

### Example A3

In this, the co-catalyst-supporting step S60 and the washing step S61 were omitted, and a pre-treating chemical, tin[II] chloride solution was sprayed on the surface of the basecoat layer 13 in the catalyst-supporting step S62. The tin[II] chloride solution used in this comprises the same components as those in Example A1 and additionally contains an oxidation-retardant component, 0.110 mol/liter of glucose. After its preparation, the solution was kept as such for 72 hours, and then used in the step S62. In this Example A3, the others than the above are the same as in Example A1. Thus fabricated, the plated article has the basecoat layer 13, the silver plate layer 14 and the topcoat layer 15 formed on the surface of the substrate layer 12.

### Comparative Example A2

As described in the description of Comparative Example A1, Comparative Example A3 is the same as Comparative Example A1.

### Example A4

A quadrilateral plate substrate layer 12 was formed through injection molding of ABS (S20), and its surface (decorative face) was pre-treated by spraying isopropanol thereon (pre-treating step S31). Next, a basecoat agent (Origin ELECTRIC CO. LTD. “E-1”) was sprayed on the surface of the substrate layer 12 (base-coating step S32). This was dried in a drying kiln at 80° C. for 60 minutes (drying step S33) to thereby form a basecoat layer 13 having a uniform thickness of about 20 μm on the surface of the substrate layer 12.

Next, a first pre-treating chemical (tin[II] chloride solution) was sprayed on the surface of the basecoat layer 13 (co-catalyst-supporting step S60), and then the surface of the basecoat layer 13 was washed by spraying ion-exchanged water having a conductivity of at most 3 μS/m³ thereon (washing step S61). The tin[II] chloride solution used in this comprises the same components as those in Example A1 and additionally contains an oxidation-retardant component, 0.110 mol/liter of glucose. After its preparation, the solution was kept as such for 24 hours and used in the step.

Next, a second pre-treating chemical (palladium chloride solution) was sprayed on the tin[II]-carrying surface of the basecoat layer 13 (catalyst-supporting step S62), and then the surface of the basecoat layer 13 was washed by spraying it with ion-exchanged water having a conductivity of at most 3 μS/m³ (washing step S42). The palladium chloride solution used in the catalyst-supporting step S62 contains 0.092 mol/liter of palladium chloride and 0.110 mol/liter of hydrochloric acid in pure water having a conductivity of 0.05 μS/m³.

Next, Metal Processing Technology Institute's “LA” and “LB” were simultaneously sprayed on the surface of the basecoat layer 13 through a twin-head spray gun (plate layer-forming step S43) to thereby form a silver plate layer 14 having a uniform thickness of about 0.1 μm on the surface of the basecoat layer 13. Next, the surface of the silver plate layer 14 was washed by spraying it with ion-exchanged water (washing step S44).

Next, a metal surface-treating agent (NaHSO₃ solution) was sprayed on the surface of the silver plate layer 14 (silver mirror post-treating step S45), and then the surface of the silver plate layer 14 was washed by spraying it with ion-exchanged water (washing step S46). Subsequently, the surface of the silver plate layer 14 was blown with compressed air (dewatering blowing step S47), and then this was dried in a drying kiln at 50° C. for 15 minutes (drying step S48).

Finally, a topcoat agent (FUJIKURAKASEI CO.,LTD. “PTC-02UH(10b)”) was sprayed on the surface of the silver plate layer 14 (top-coating step S51), and then dried in a drying kiln at 80° C. for 60 minutes (drying step S52) to thereby form a topcoat layer 15 having a uniform thickness of about 20 μm on the surface of the silver plate layer 14. Thus fabricated, the plated article 11 has the basecoat layer 13, the silver plate layer 14 and the topcoat layer 15 formed on the surface of the substrate layer 12.

### Example A5

In Example A5, a topcoat agent (Origin ELECTRIC CO. LTD. “Origituke #100”) was sprayed on the surface of the silver plate layer 14 (top-coating step S51), and then dried in a drying kiln at 80° C. for 30 minutes (drying step S52) to thereby form a topcoat layer 15 on the surface of the silver plate layer 14. In this Example A5, the others than the above are the same as in Example A4.

### Example A6

In Example A5, a topcoat agent (FUJIKURAKASEI CO.,LTD. “PTC-05N”) was sprayed on the surface of the silver plate layer 14 (top-coating step S51), and then dried in a drying kiln at 80° C. for 60 minutes (drying step S52) to thereby form a topcoat layer 15 on the surface of the silver plate layer 14. In this Example A6, the others than the above are the same as in Example A4.

<Test for Accelerated Corrosion Resistance>

The plated articles 11 of Examples A1 to A3 and the plated articles of Comparative Examples A1 to A3 were subjected to a salt spray test for accelerated corrosion resistance. Concretely, the plated articles were put in a laboratory chamber, in which they were sprayed with an aqueous solution of 5 wt. % sodium chloride having a controlled pH of from 6.5 to 7.2, at 35° C. for 240 hours. After that, the plated articles were taken out of the chamber, and then washed with flowing water. After thus tested with salt spraying, the outward appearance of every plated article was checked for surface corrosion. Concretely, the mirror face of every plated article was visually checked as to whether or not it was decolored or fogged.

After the salt spray test, every plated article was cut with a needle or a cutter knife to form cross-cuts that penetrate through the silver plate layer 14 thereof. Thus cut, the plated articles were subjected to a taping test (JIS G0202). Concretely, an adhesive Cellophane tape was attached to every plated article and it was rapidly peeled off to visually evaluate the adhesiveness of the silver plate layer 14 to the underlying basecoat layer 13. On the other hand, the plated articles after the salt spray test were not cut, and subjected to a taping test (dry taping test). Concretely, an adhesive Cellophane tape was attached to every plated article not cut, and it was rapidly peeled off to visually evaluate the adhesiveness of the silver plate layer 14 to the underlying basecoat layer 13. Regarding the test for accelerated corrosion resistance, the plated articles of Example A1 and Comparative Example A1 were left as such for 3 days after the drying step S52 and then subjected to the test, while those of Examples A2 and A3 and Comparative Examples A2 and A3 were left as such for 10 days after the drying step S52 and then subjected to the test. FIG. 7 shows the test results.

First compared were Example A1 and Comparative Example A1 to investigate the influence of the standard electrode potential difference between the silver to form the silver plate layer 14 and the catalyst used, on the corrosion resistance of the plated articles. As in FIG. 7, the plated articles of Example A1 in which the standard electrode potential difference is 0.19 eV in terms of the absolute value are all good in point of all the tested items of the outward appearance and the adhesiveness of the silver plate layer 14 in the products. As opposed to these, the plated articles of Comparative Example A1 in which the standard electrode potential difference is 0.65 eV in terms of the absolute are good only in point of the outward appearance but are not good in point of the plate layer adhesiveness. In addition, it was confirmed that, after the accelerated corrosion resistance test, the silver plate layer 14 of the plated articles of Comparative Example A1 became gradually decolored and its gloss became gradually lowered with the lapse of time. As opposed to these, there was found little time-dependent decoloration and gloss reduction in the silver plate layer 14 of the plated articles of Example A1.

Next compared were Example A2 and Comparative Example A2 to investigate the influence of the proportion of the active ingredient that actually serves as the catalyst to the overall catalyst component in the tin[II] chloride solution, on the corrosion resistance of the plated articles. As in FIG. 7, the plated articles of Example A2, in which the active ingredient accounts for 99% of all the catalyst component of the solution used, are all good in point of all the tested items of the outward appearance and the plate layer adhesiveness. As opposed to these, the plated articles of Comparative Example A2, in which the active ingredient accounts for 88% of all the catalyst component of the solution used, are good only in point of the outward appearance but are not good in point of the plate layer adhesiveness. In addition, it was confirmed that, after the accelerated corrosion resistance test, the silver plate layer of the plated articles of Comparative Example A2 became gradually decolored and its gloss became gradually lowered with the lapse of time. As opposed to these, there was found little time-dependent decoloration and gloss reduction in the silver plate layer 14 of the plated articles of Example A2.

Next compared were Example A3 and Comparative Example A3 to investigate the influence the presence or absence of the oxidation-retardant component in the pre-treating chemical used, on the corrosion resistance of the plated articles. As in FIG. 7, the plated articles of Example A3, in which the pre-treating chemical used in forming the silver plate layer 14 contained the oxidation-retardant component, are all good in point of all the tested items of the outward appearance and the plate layer adhesiveness. As opposed to these, the plated articles of Comparative Example A3, which the pre-treating chemical used in forming the silver plate layer 14 did not contain the oxidation-retardant component, are good only in point of the outward appearance but are not good in point of the plate layer adhesiveness. In addition, it was confirmed that, after the accelerated corrosion resistance test, the silver plate layer of the plated articles of Comparative Example A3 became gradually decolored and its gloss became gradually lowered with the lapse of time. As opposed to these, there was found little time-dependent decoloration and gloss reduction in the silver plate layer 14 of the plated articles of Example A3.

Further, similar to Examples A1 to A3, there was found little time-dependent decoloration and gloss reduction in the silver plate layer 14 of the plated articles of Examples A4 to A6.

### Example B1

A quadrilateral plate substrate layer 12 was formed through injection molding of ABS, and its surface (decorative face) was pre-treated by spraying isopropanol thereon (pre-treating step S131). Next, a basecoat agent of a two-pack curable polyurethane resin (from Origin Electric) was sprayed on the surface of the substrate (base-coating step S132). This was dried in a drying kiln at 80° C. for 60 minutes (drying step S133) to thereby form a basecoat layer 13 having a uniform thickness of about 20 μm on the surface of the substrate.

Next, a tin[II] chloride solution that contains 3% by weight of tin[II] chloride and 1% by weight of hydrochloric acid was sprayed on the surface of the basecoat layer 13 (silver mirror pre-treating step (1) of S141), and then the surface of the basecoat layer 13 was sprayed with ion-exchanged water (preferably having a conductivity of at most 3 μS/m³) to wash it (washing step S142). Next, a palladium chloride solution (5 wt. % solution of Okuno Pharmaceutical's “Activator”) was sprayed on it (silver mirror pre-treating step (2) of S143), and then the surface of the basecoat layer 13 was sprayed with ion-exchanged water (preferably having a conductivity of at most 3 μS/m³) to wash it (washing step S144). Next, Tollens' reagent and glyoxal were simultaneously sprayed on the surface of the basecoat layer 13 through a twin-head spray gun (silver mirror-coating step S151) to thereby form a silver plate layer 14 having a uniform thickness of about 1000 Å on the surface of the basecoat layer 13. Next, the surface of the silver plate layer 14 was washed by spraying it with ion-exchanged water (washing step S152).

Next, a post-treating solution of 1 wt. % sodium hydrogensulfite was sprayed on the surface of the silver plate layer 14 (silver mirror post-treating step S153), and then the surface of the silver plate layer 14 was washed by spraying it with ion-exchanged water (washing step S154). Subsequently, the surface of the silver plate layer 14 was blown with compressed air (dewatering blowing step S155), and then this was dried in a drying kiln at 70° C. for 30 minutes (drying step S156).

Finally, a silicon-acrylic topcoat agent (FUJIKURAKASEI CO.,LTD. “PTC-02UH(10B)”) was sprayed on the surface of the silver plate layer 14 (top-coating step S161), and then dried in a drying kiln at 80° C. for 60 minutes (drying step S162) to thereby form a topcoat layer 15 having a uniform thickness of about 20 μm on the surface of the silver plate layer 14. Thus fabricated, the plated article 111 has the basecoat layer 13, the silver plate layer 14 and the topcoat layer 15 formed on the surface of the substrate. The plated article 111 is subjected to a pull-off test (JIS-K5400, Item 8.7) to determine the tensile strength per the unit surface area thereof. This indicates the adhesion strength between the silver plate layer 14 and the topcoat layer 15. In addition, the outward appearance of the plated article 111 was visually evaluated.

<Pull-off Test>

The pull-off test is as follows: A pulling tool is stuck to the coated surface of a plated sample with an epoxy adhesive put therebetween, and it is pulled in the direction vertical to the coated surface of the sample. The load under which the coating layer peels off from the plated sample is read. In the embodiment of the invention, a standard tool is stuck to the surface of the plated article 111 with an epoxy adhesive put therebetween, and this is pulled in the direction vertical to the surface of the plated article 111. The tensile strength at which the topcoat layer 15 peels off from the silver plate layer is read.

### Example B2

A plated article was fabricated in the same manner as in Example B1. In this, however, a post-treating solution of 10 wt. % sodium hydrogensulfite was sprayed on the surface of the silver plate layer 14 in the silver mirror post-treating step S153. Thus fabricated, the plated article was subjected to the pull-off test and its outward appearance was evaluated.

### Example B3

A plated article was fabricated in the same manner as in Example B1. In this, however, a post-treating solution of 35 wt. % sodium hydrogensulfite was sprayed on the surface of the silver plate layer 14 in the silver mirror post-treating step S153. Thus fabricated, the plated article was subjected to the pull-off test and its outward appearance was evaluated.

### Example B4

A plated article was fabricated in the same manner as in Example B1. In this, however, a post-treating solution of 1 wt. % acetic acid was sprayed on the surface of the silver plate layer 14 in the silver mirror post-treating step S153. Thus fabricated, the plated article was subjected to the pull-off test and its outward appearance was evaluated.

### Example B5

A plated article was fabricated in the same manner as in Example B1. In this, however, a post-treating solution of 10 wt. % acetic acid was sprayed on the surface of the silver plate layer 14 in the silver mirror post-treating step S153. Thus fabricated, the plated article was subjected to the pull-off test and its outward appearance was evaluated.

### Example B6

A plated article was fabricated in the same manner as in Example B1. In this, however, a post-treating solution of 30 wt. % acetic acid was sprayed on the surface of the silver plate layer 14 in the silver mirror post-treating step S153. Thus fabricated, the plated article was subjected to the pull-off test and its outward appearance was evaluated.

### Example B7

A plated article was fabricated in the same manner as in Example B1. In this, however, a post-treating solution of 60 wt. % acetic acid was sprayed on the surface of the silver plate layer 14 in the silver mirror post-treating step S153. Thus fabricated, the plated article was subjected to the pull-off test and its outward appearance was evaluated.

### Example B8

A plated article was fabricated in the same manner as in Example B1. In this, however, a post-treating solution of 80 wt. % acetic acid was sprayed on the surface of the silver plate layer 14 in the silver mirror post-treating step S153. Thus fabricated, the plated article was subjected to the pull-off test and its outward appearance was evaluated.

### Example B9

A plated article was fabricated in the same manner as in Example B1. In this, however, a post-treating solution of 1 wt. % calcium hydrogensulfite was sprayed on the surface of the silver plate layer 14 in the silver mirror post-treating step S153. Thus fabricated, the plated article was subjected to the pull-off test and its outward appearance was evaluated.

### Example B10

A plated article was fabricated in the same manner as in Example B1. In this, however, a post-treating solution of 1 wt. % oxalic acid was sprayed on the surface of the silver plate layer 14 in the silver mirror post-treating step S153. Thus fabricated, the plated article was subjected to the pull-off test and its outward appearance was evaluated.

### Example B11

A plated article was fabricated in the same manner as in Example B1. In this, however, a post-treating solution of 1 wt. % sodium hydrogensulfite was sprayed on the surface of the silver plate layer 14 in the silver mirror post-treating step S153; and a topcoat agent of Origin ELECTRIC CO. LTD. “E-1” was used in the top-coating step S161, and it was dried at a temperature of 80° C. for 45 minutes in the drying step S162 to form the topcoat layer 15. Thus fabricated, the plated article was subjected to the pull-off test and its outward appearance was evaluated.

### Comparative Example B1

A plated article was fabricated in the same manner as in Example B1. In this, however, the surface of the silver plate layer 14 was not processed with the post-treating solution. Thus fabricated, the plated article was subjected to the pull-off test and its outward appearance was evaluated.

### Comparative Example B2

A plated article was fabricated in the same manner as in Example B1. In this, however, a post-treating solution of 0.1 wt. % sodium hydrogensulfite was sprayed on the surface of the silver plate layer 14 in the silver mirror post-treating step S153. Thus fabricated, the plated article was subjected to the pull-off test and its outward appearance was evaluated.

### Comparative Example B3

A plated article was fabricated in the same manner as in Example B1. In this, however, a post-treating solution of 0.1 wt. % acetic acid was sprayed on the surface of the silver plate layer 14 in the silver mirror post-treating step S153. Thus fabricated, the plated article was subjected to the pull-off test and its outward appearance was evaluated.

### Comparative Example B4

A plated article was fabricated in the same manner as in Example B1. In this, however, after the silver mirror-coating step to form the silver plate layer 14, a post-treating solution of 1 wt. % hydrochloric acid was sprayed on the surface of the silver plate layer 14 in the silver mirror post-treating step S153. Thus fabricated, the plated article was subjected to the pull-off test and its outward appearance was evaluated.

### Comparative Example B5

A plated article was fabricated in the same manner as in Example B1. In this, however, after the silver mirror-coating step to form the silver plate layer 14, a post-treating solution of 1 wt. % sulfuric acid was sprayed on the surface of the silver plate layer 14 in the silver mirror post-treating step S153. Thus fabricated, the plated article was subjected to the pull-off test and its outward appearance was evaluated.

The data of the tensile strength of the samples in the pull-off test and the result of the outward appearance evaluation of the samples are given in Table 1.

### Comparative Example B6

A plated article was fabricated in the same manner as in Example B1. In this, however, the silver plate layer 14 was not processed with the post-treating solution, or that is, the silver mirror post-treating step S153 was omitted herein; and a topcoat agent of Origin ELECTRIC CO. LTD. “E-1” was used in the top-coating step S161, and it was dried at a temperature of 80° C. for 45 minutes in the drying step S162 to form the topcoat layer 15. Thus fabricated, the plated article was subjected to the pull-off test and its outward appearance was evaluated.

TABLE 1

| | Tensile Strength in | |
|---|---|---|
| | Pull-off Test (MPa) | Outward Appearance |
| Example B1 | 1.3 | ∘ |
| Example B2 | 1.8 | ∘ |
| Example B3 | 2.4 | ∘ |
| Example B4 | 1.3 | ∘ |
| Example B5 | 1.5 | ∘ |
| Example B6 | 1.8 | x |
| Example B7 | 1.6 | x |
| Example B8 | 2.0 | x |
| Example B9 | 1.2 | ∘ |
| Example B10 | 1.2 | ∘ |
| Example B11 | 1.5 | ∘ |
| Comp. Example B1 | 0.9 | ∘ |
| Comp. Example B2 | 1.0 | ∘ |
| Comp. Example B3 | 1.0 | ∘ |
| Comp. Example B4 | 0.9 | x |
| Comp. Example B5 | 0.9 | x |
| Comp. Example B6 | 0.8 | ∘ |

∘: Good.
x: Surface gloss lowered.

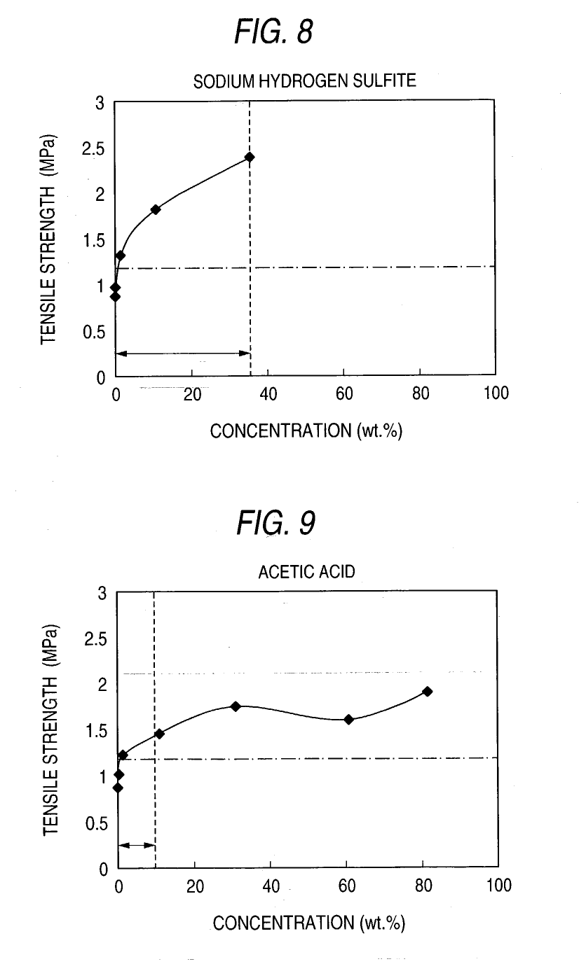

The relationship between the concentration of the post-treating solution for the silver plate layer 14, sodium hydrogensulfite or acetic acid, and the tensile strength of the plated samples in the pull-off test is shown in FIG. 8 and FIG. 9. The data in Table 1 and FIGS. 8 and 9 are discussed with reference to Examples B1 to B3 and Comparative Examples B1 and B2.

When the concentration of sodium hydrogensulfite in the post-treating solution is not higher than 0.1% by weight, the tensile strength of the plated samples in the pull-off test is not higher than 1 MPa. However, when the concentration of sodium hydrogensulfite in the solution is 1% by weight or more, the tensile strength of the plated samples may be 1.3 MPa or more. As in FIG. 8, the tensile strength of the plated samples increases with the increase in the concentration of sodium hydrogensulfite in the post-treating solution to 1, 10 and 35% by weight. However, more sodium hydrogensulfite than 35% by weight could not dissolve in water, the sodium hydrogensulfite concentration in the post-treating solution for the silver plate layer 14 must be at most 35% by weight. The plated samples in Examples B1 to B3 and Comparative Examples B1 and B2 all have a good outward appearance. For these reasons, the suitable range of the sodium hydrogensulfite concentration of the post-treating solution for the silver plate layer 14 falls between 1 and 35% by weight.

Next discussed are the results of the cases where acetic acid was used for the post-treating solution for the silver plate layer 14 with reference to the data of Examples B4 to B8 and Comparative Examples B1 and B3. When the acetic acid concentration of the post-treating solution is not higher than 0.1% by weight, the tensile strength of the plated samples in the pull-off test is not higher than 1 MPa. However, when the acetic acid concentration of the solution is 1% by weight or more, the tensile strength of the plated samples may be 1.3 MPa or more. On the other hand, when the acetic acid concentration is 30, 60 or 80% by weight, it lowered the surface gloss of the silver plate layer 14 and the outward appearance of the plated articles 111 was not good. This will be because, when the acetic acid concentration of the post-treating solution increases too much, the solution would etch the surface of the silver plate layer 14 and the layer 14 would lose its mirror surface. When the acetic acid concentration of the post-treating solution is 1 or 10% by weight, the outward appearance of the plated articles is good. From these, it is believed that the suitable range of the acetic acid concentration of the post-treating solution for the silver plate layer 14 falls between 1 and 10% by weight.

The cases where acetic acid having a relatively low acid strength is used for the post-treating solution for the silver plate layer 14 are compared with the cases where hydrochloric acid or sulfuric acid having a strong acid strength for it, with reference to Example B4 and Comparative Examples B4 and B5. When 1 wt. % hydrochloric acid or sulfuric acid is used for the post-treating solution for the silver plate layer 14, the tensile strength of the plated samples in the pull-off test is smaller than 1 MPa. In addition, the outward appearance of the plated samples is not good, as their surface gloss is low. This will be because hydrochloric acid and sulfuric acid both have a high acid strength and therefore would have etched the surface of the silver plate layer 14, and, as a result, the layer 14 would have lost its mirror surface. On the other hand, when 1 wt. % acetic acid is used for the post-treating solution for the silver plate layer 14, the tensile strength of the plated samples in the pull-off test is 1.3 MPa or more and the outward appearance thereof is good.

The other cases where 1 wt. % calcium hydrogensulfite or oxalic acid is used for the post-treating solution for the silver plate layer 14 are discussed with reference to the data of Examples B9 and B10. Since calcium hydrogensulfite readily releases its sulfite ion, it gives hydroxyl groups of extremely high polarity to the surface of the silver plate layer 14 processed with it, and, as a result, the adhesion strength of the layer 14 to the topcoat layer 15 is thereby increased. On the other hand, since oxalic acid is a weak organic acid having a relatively low acid strength, it gives hydroxyl groups to the surface of the silver plate layer 14 not detracting from the mirror surface of the layer 14, so far as its concentration is controlled to be not higher than a predetermined level, and, as a result, the adhesion strength of the layer 14 to the topcoat layer 15 is thereby increased. Accordingly, when 1 wt. % calcium hydrogensulfite or oxalic acid is used for the post-treating solution for the silver plate layer 14, the tensile strength of the plated samples in the pull-off test may be 1.2 MPa or more. In addition, the outward appearance of the plated samples is good.

The cases in which Origin ELECTRIC CO. LTD. “E-1” is used for the topcoat agent are discussed with reference to the data of Example B11 and Comparative Example B6. When the surface of the silver plate layer 14 is processed with a post-treating solution of 1 wt. % sodium hydrogensulfite, the tensile strength of the plated sample in the pull-off test is 1.5 MPa. On the other hand, however, when the layer 14 is not processed with the post-treating solution, the tensile strength of the plated sample is only 0.8 MPa. Regarding their outward appearance, the plated samples of Example B11 and Comparative Example B6 are all good. This confirms that, when the surface of the silver plate layer 14 is processed with sodium hydrogensulfite of a predetermined concentration, then the plated samples are all good irrespective of the type of the topcoat agent applied thereto, either Origin ELECTRIC CO. LTD. “E-1” or FUJIKURAKASEI CO.,LTD. “PTC-02UH(10B)”.

As described in detail hereinabove, the invention solves the problems of decoloration and delamination of the metal plate layer of plated articles that may be caused by the metal corrosion in the metal plate layer.

An additional advantage of the invention is that the silver plate layer of plated articles is kept bright for a long period of time.

Further an additional advantage of the invention is that the corrosion-resistant metal plate layer is easy to form.

An additional advantage of the invention is that silver of the silver plate layer is well prevented from being corroded.

Furthermore, the invention enables effective metal deposition to form a good metal plate layer, and it gives plated articles of high quality. In addition, it solves the problems of decoloration and delamination of the metal plated layer.

In the invention, the pre-treating chemical to be used in forming the metal plate layer contains a larger amount of the active ingredient. The concentration of the active ingredient of the pre-treating chemical does not lower, and the pre-treating chemical can be kept stable for a relatively long period of time, and in addition, its maintenance is easy. In the catalyst-supporting step, the pre-treating chemical to be used is subjected to oxidation retardation and it enables efficient deposition of metal to form the metal plate layer. The invention produces plated articles of high quality. In case where the non-active ingredient in the pre-treating chemical has a high affinity for substances such as oxygen and chlorine that promote the corrosion of the metal of the metal plate layer, the invention is more effective for preventing decoloration and delamination of the metal plate layer.

By the above, the pre-treating chemical can be readily stabilized.

Additional advantages of the invention are that the concentration of the active ingredient of the pre-treating chemical does not lower, and the pre-treating chemical can be kept stable for a longer period of time, and in addition, its maintenance is easier.

The invention makes it possible to more effectively prevent the metal of the metal plate layer of the plated articles from being corroded. Accordingly, the plated articles produced according to the invention can be used under any severe conditions.

As described in detail hereinabove, the invention of has the advantage of increasing the adhesion strength between the metal plate layer and the topcoat layer in plated articles and solving the problem of delamination of the two layers at their interface.

Although the first and second embodiments of the invention are described separately, the two can be embodied in the same plated article.

The technical idea that may be grasped from the description of the embodiments and their modifications is described below along with its advantages.

(A) A method for producing plated articles of the invention, in which the metal plate layer is a silver plate layer formed through chemical plating based on silver mirror reaction.

Additional advantage of the above (A) is that the silver plate layer is formed in an extremely simple process of silver deposition. The working operation for silver deposition to form the silver plate layer is effected extremely rapidly, and the embodiment reduces the production costs.

(B) A method for producing plated articles of the invention, in which the substrate layer is formed of synthetic resin.

In addition to the advantages of the invention, an additional advantage of the embodiment (B) is that the plated articles are lightweight, and still another advantage thereof is that the embodiment allows a lot of latitude in producing plated articles of different shapes.

(C) A method for producing plated articles, in which the metal plate layer is a silver plate layer formed through chemical plating based on silver mirror reaction.

In addition to the advantages of the invention, an additional advantage of the (C) is that the silver plate layer is formed in an extremely simple process of silver deposition. The working operation for silver deposition to form the silver plate layer is effected extremely rapidly, and the embodiment reduces the production costs.

(D) A method for producing plated articles, in which the substrate layer is formed of synthetic resin.

In addition to the advantages of the invention, an additional advantage of the embodiment (D) is that the plated articles are lightweight, and still another advantage thereof is that the embodiment allows a lot of latitude in producing plated articles of different shapes.

What is claimed is:

1. A plated article having at least a metal plate layer on the surface of a substrate layer;
in which the metal plate layer is formed with a catalyst supported on the substrate layer or on a lower layer formed between the metal plate layer and the substrate layer, and in which the difference in the standard electrode potential between the metal to form the metal plate layer and the substance to be the catalyst is smaller than 0.65 eV in terms of the absolute value.

2. A plated article as claimed in claim 1, wherein the metal plate layer is coated with an upper layer for protection.

3. A plated article as claimed in claim 1, wherein the metal to form the metal plate layer is silver.

4. A method for producing a plated article having at least a metal plate layer on a surface of a substrate layer, the method comprising steps of:
a catalyst-supporting step of making a substance to be a plating catalyst supported on a surface of a lower layer that underlies the metal plate layer on the condition that the difference in the standard electrode potential between the metal to form the metal plate layer and the substance to be the plating catalyst is smaller than 0.65 eV in terms of the absolute value; and
a plating step of forming the metal plate layer on the catalyst-carrying lower layer.

5. A method for producing a plated article as claimed in claim 4, further comprising a co-catalyst-supporting step of making a co-catalyst supported on the surface of the lower layer prior to the catalyst-supporting step and in which the co-catalyst is to assist the catalyst supporting onto the surface of the lower layer.

6. A method for producing a plated article as claimed in claim 4, wherein the metal to form the metal plate layer is silver.

7. A method for producing a plated article as claimed in claim 6, wherein the difference in the standard electrode potential between the catalyst and silver is at most 0.2 eV in terms of the absolute value.

8. A method for producing a plated article having at least a metal plate layer on a surface of a substrate layer, the method comprising steps of:
a plating step of forming the metal plate layer and
a catalyst-supporting step of making a catalyst, tin[II] supported on a surface of a lower layer that underlies the metal plate layer;
wherein tin[II] for the catalyst accounts for at least 95% of all tin in the pre-treating chemical used in the catalyst-supporting step.

9. A method for producing a plated article having at least a metal plate layer on the surface of a substrate layer, the method comprising steps of;
a plating step of forming the metal plate layer and
a catalyst-supporting step of making a catalyst supported on a surface of a lower layer that underlies the metal plate layer;
wherein the pre-treating chemical used in the catalyst-supporting step is subjected to oxidation retardation for retarding the oxidation of the active ingredient of the chemical that actually serves as the catalyst in the plating step.

10. A method for producing a plated article as claimed in claim 9, wherein the treatment for oxidation retardation of the pre-treating chemical includes adding thereto an oxidation-retardant component effective for retarding the oxidation of the active ingredient of the pre-treating chemical.

11. A method for producing a plated article as claimed in claim 10, wherein the oxidation-retardant component is a polyalcohol.

12. A method for producing a plated article as claimed in claim 9, wherein the treatment for oxidation retardation of the pre-treating chemical includes preparing the pre-treating chemical by adding a solute or a dispersoid to a medium from which the dissolved oxygen has been degassed.

13. A method for producing a plated article as claimed in claim 9, wherein the treatment for oxidation retardation of the pre-treating chemical includes degassing the dissolved oxygen from the pre-treating chemical.

14. A method for producing a plated article as claimed in claim 9, wherein the treatment for oxidation retardation of the pre-treating chemical includes keeping the pre-treating chemical under the conditions under which any oxygen transmission is blocked out between the environment where the pre-treating chemical is disposed and the external environment divided from that environment.

15. A method for producing a plated article, comprising steps of:
combining a production method of claim 4 and a production method of claim 9 for forming the plate layer of the plated article.

16. A method for producing a plated article, comprising steps of:
combining a production method of claim 8 and a production method of claim 9 for forming the plate layer of the plated article.

17. A method for producing a plated article having a basecoat layer, a metal plate layer and a topcoat layer on a surface of a substrate, the method comprising steps of:
forming the basecoat layer and the metal plate layer on the surface of the substrate;
processing a surface of the metal plate layer with a reducing solution; and
forming the topcoat layer on the surface of the metal plate layer.

18. A method for producing a plated article as claimed in claim 17, wherein the reducing solution contains a substance that releases a sulfite ion in an aqueous solution.

19. A method for producing a plated article as claimed in claim 18, wherein the reducing solution is an aqueous solution of at least one substance selected from sulfurous acid, sulfites and hydrogensulfites.

20. A method for producing a plated article as claimed in claim 17, wherein the reducing solution contains a substance that releases a divalent metal ion in an aqueous solution.

21. A method for producing a plated article as claimed in claim 20, wherein the reducing solution is an aqueous solution of at least one substance selected from Sn(II) salts or Fe(II) salts.

22. A method for producing a plated article as claimed in claim 17, wherein the reducing solution is an aqueous solution of an organic acid.

23. A method for producing a plated article as claimed in claim 22, wherein the organic acid is selected from oxalic acid, formic acid, malonic acid, acetic acid, succinic acid, propionic acid, glutaric acid and butyric acid.

24. A method for producing a plated article having a basecoat layer, a metal plate layer and a topcoat layer on a surface of a substrate, comprising steps of:
forming the basecoat layer and the metal plate layer on the surface of the substrate;
processing a surface of the metal plate layer with an organic carboxylic acid solution; and
forming the topcoat layer on the surface of the metal plate layer.

25. A method for producing a plated article as claimed in claim 24, wherein the organic carboxylic acid solution is an aqueous solution of at least one substance selected from oxalic acid, formic acid, malonic acid, acetic acid, succinic acid, propionic acid, glutaric acid and butyric acid.

26. A method for producing a plated article as claimed in claim 17, wherein a metal to form the metal plate layer is silver.
